(19) United States
(12) Patent Application Publication
(10) Pub. No.: US 2023/0405888 A1
(43) Pub. Date: Dec. 21, 2023

(54) A COMPRESSION MOULDING METHOD AND APPARATUS

(71) Applicant: SACMI COOPERATIVA MECCANICI IMOLA SOCIETA' COOPERATIVA, 40026 IMOLA (BOLOGNA) (IT)

(72) Inventors: FABRIZIO PUCCI, CASTEL GUELFO DI BOLOGNA (BO) (IT); FIORENZO PARRINELLO, MEDICINA (BO) (IT)

(21) Appl. No.: 18/040,354

(22) PCT Filed: Aug. 5, 2021
(86) PCT No.: PCT/IB2021/057183

§ 371 Date: Feb. 2, 2023

(30) Foreign Application Priority Data
Aug. 5, 2020 (IT) 102020000019351
Aug. 5, 2020 (IT) 102020000019360
Dec. 23, 2020 (IT) 102020000032156

(51) Int. Cl. B29C 43/36; B29C 43/34

(52) U.S. Cl. CPC B29C 43/361; B29C 43/34; B29C 2043/3602; B29C 2043/3613; B29C 2043/3621

(57) ABSTRACT

A method for forming an object comprises the steps of:
providing a mould comprising a first and a second mould part opposite to each other, a part selected from between the first mould part and the second mould part comprising a plurality of sectors for shaping a lateral portion of the object, the sectors delimiting a variable-volume forming region of the mould;
positioning a dosed amount of mouldable material between the first and second mould parts while the mould is in an open position;
displacing the first mould part and the second mould part towards each other in a moulding direction, to define between the first mould part and the second mould part a closed forming chamber bringing into contact respective abutment surfaces of the first mould part and the second mould part, the abutment surfaces extending transversely to the moulding direction.

The invention relates to a method and apparatus for producing objects by compression moulding a mouldable material.

The mouldable material which can be manipulated in the method and apparatus according to the invention is, for example, a synthetic polymeric material.

Compression moulding apparatuses for producing objects in polymeric material are known. The known apparatuses comprise an extruder from which a continuous extrudate of polymeric material outflows and one or more cutting elements for cutting the continuous extrudate in order to separate consecutive doses of polymeric material from the latter. The known apparatuses further comprise one or more moulds for receiving corresponding doses of polymeric material and making an object from each dose.

The doses used in the known apparatuses usually have a simple shape, for example spherical or cylindrical, for reasons related to the production methods thereof. The shape of the doses is often very different from the objects to be produced. This may in some cases create inconveniences due to the difficulties in correctly inserting the dose into the mould.

In particular, cases may occur in which the mould has a forming cavity having a small transverse dimension with respect to the dose dimensions, because the corresponding dimension of the object to be produced is small. It may even occur that the dose cannot be introduced into the forming cavity, because a transverse dimension of the forming cavity is smaller than the corresponding transverse dimension of the dose.

If this occurs, the object cannot be produced by compression moulding, unless doses having a relatively complex shape, closer to the shape of the forming cavity, are used, which is not always possible and in any case requires complicated devices for producing the dose.

US 2006/0034973 discloses a mould for producing containers such as crates, by moulding a plastic material. The plastic material is injected into a cavity of the mould, while the mould is in a closed position. A portion of the lateral wall of the mould cavity is subsequently moved to reduce the volume of the cavity and form the container.

U.S. Pat. No. 5,378,416 discloses a method for making a mould from a powder, in which the mould has an undercut portion. A mould is used which comprises two movable plated-like elements moving away from each other to disengage from the undercut portion of the object and allow the object to be extracted from the mould. The plate-like elements are therefore movable to increase the volume of a forming chamber from which the moulded object must be extracted.

FR 1549502 discloses a device for compacting optical fibres, comprising six sectors arranged around an axis and a steel ring which acts on the sectors to bring them closer to the axis, reducing the distance between pairs of facing sectors. The device comprises a housing and a cover which can be removed to introduce the optical fibres between the sectors and subsequently reapplied. In FR 1549502, it is not possible to define a moulding direction. Furthermore, the device disclosed in FR 1549502 does not apply any axial compression action on the optical fibres, as the distance between two graphite blocks, which are arranged respectively above and below the optical fibres, is constant.

An object of the invention is to improve the compression moulding apparatuses and methods for producing objects in mouldable material, for example in synthetic polymeric material.

A further object is to improve the manners of introducing a dosed amount of mouldable material into a mould to be used to produce an object.

Another object is to make it possible, by compression moulding of a dosed amount of mouldable material, to also produce objects having a small transverse dimension with respect to a dimension of the dosed amount of mouldable material.

In a first aspect of the invention, a method is provided for forming an object, comprising the steps of:
providing a mould comprising a first mould part and a second mould part opposite to each other, one part selected from between the first mould part and the second mould part comprising a plurality of sectors for shaping at least a lateral portion of the object, the sectors of said plurality delimiting a variable-volume forming region of the mould;
positioning a dosed amount of mouldable material between the first mould part and the second mould part;
displacing the first mould part and the second mould part towards each other in a moulding direction, to define between the first mould part and the second mould part a closed forming chamber, by bringing into contact respective abutment surfaces of the first mould part and the second mould part, the abutment surfaces extending transversely to the moulding direction,
   the method further comprising the step of moving the sectors of said plurality transversely to the moulding direction to reduce volume of the variable-volume forming region.

Owing to the first aspect of the invention, a variable-volume forming region may be made available in the mould. A dosed amount of mouldable material having a relatively large size and a shape completely different from the object to be obtained can be introduced in the variable-volume forming chamber. This allows to produce, with compression moulding technology, a multiplicity of objects of different shapes and sizes starting from dosed amounts having a simple geometry, which are therefore easy to obtain and manipulate.

In an embodiment, the dosed amount of mouldable material is positioned between the first mould part and the second mould part while the mould is in an open position, i.e., while the first mould part and the second mould part are in a position spaced apart from each other.

In an embodiment, the mould comprises a forming component which penetrates the variable-volume forming region, compressing the mouldable material in the moulding direction.

The forming component allows to progressively reduce a size of the forming chamber along the moulding direction. In other words, the forming component allows to progressively decrease a thickness of the object which is about to be formed, said thickness being measured in a direction parallel to the moulding direction.

It is thus possible to compress the mouldable material both parallel to the moulding direction and transversely to the moulding direction.

In one version, the step of moving the sectors of said plurality transversely to the moulding direction starts before the closed forming chamber has been defined, i.e., before the respective abutment surfaces of the first mould part and the second mould part have been brought into mutual contact.

This allows to start reducing the volume of the variable-volume forming region immediately after having introduced the dosed amount of mouldable material into the mould, without waiting for the forming chamber to be closed.

In particular, the step of moving the sectors of said plurality can also start before the first mould part and the second mould part begin to be displaced towards each other to define the closed forming chamber.

In an embodiment, the sectors of said plurality are movable between a first position and a second position. In the first position, the sectors of said plurality define an enlarged configuration of the variable-volume forming region. In the second position, the sectors of said plurality define a final configuration of the variable-volume forming region.

In an embodiment, the dosed amount is deposited on a part selected from between the first mould part and the second mould part while the dosed amount has, transversely (more specifically, perpendicular) to the moulding direction, smaller dimensions than the corresponding dimensions of the variable-volume forming region in the enlarged configuration, transversely (more specifically, perpendicular) to the moulding direction.

This prevents the dosed amount from prematurely touching the sectors, which could cause undesired deformations of the dosed amount and/or compromise the correct positioning of the dosed amount in the mould.

In an embodiment, the second position is reached before the closed forming chamber has been defined.

In this case, the first mould part and the second mould part are brought into contact only after having reached the final configuration of the variable-volume forming region.

In an embodiment, the sectors of said plurality (which are included in a mould part selected from between the first mould part and the second mould part) face the other mould part selected from between the second mould part and the first mould part, so as to be in contact with the other mould part after the closed forming chamber has been defined.

By bringing the sectors to the second position, corresponding to the final configuration of the variable-volume forming region, before defining the closed forming chamber, it is possible to prevent the sectors from sliding in contact with the mould part facing them while they are being brought to the second position. This thereby reduces the friction which the sectors must overcome to move from the first position to the second position.

In an embodiment, the mould part facing the sectors of said plurality can comprise a blocking portion, intended to engage with an edge zone of the dosed amount to press the edge zone against a forming element of the mould part to which the sectors are associated, so as to block the dosed amount in contact with the forming element while the dosed amount is being shaped.

The blocking portion avoids undesired displacements of the dosed amount during the forming.

In an alternative embodiment, it is possible that the step of moving the sectors of said plurality transversely to the moulding direction starts before the closed forming chamber has been defined, but that the second position of the sectors is reached after the forming chamber has been closed.

In another alternative embodiment, the step of moving the sectors of said plurality transversely to the moulding direction starts after the closed forming chamber has been defined.

This prevents the mouldable material from outflowing the mould in an undesirable manner due to the movement of the sectors.

In an embodiment, the first mould part is a female mould part, while the second mould part is a male mould part.

The first mould part can be arranged below the second mould part.

Alternatively, the first mould part can be arranged above the second mould part.

It may therefore occur that the female mould part is arranged below the male mould part or, alternatively, that the female mould part is arranged above the male mould part.

The step of positioning a dosed amount of mouldable material between the first mould part and the second mould part can comprise depositing the dosed amount on a mould part, selected from between the first mould part and the second mould part, which is below the other mould part, selected from between the second mould part and the first mould part.

The sectors of said plurality can be included in the first mould part or alternatively in the second mould part.

It is therefore possible that the sectors of said plurality are associated with the female mould part or with the male mould part.

In an embodiment, the step of displacing the first mould part and the second mould part towards each other in a moulding direction occurs by means of a driving device which moves at least one mould part selected from between the first mould part and the second mould part towards the other mould part selected from between the second mould part and the first mould part.

In an embodiment, the sectors of said plurality are associated with the mould part moved by the driving device.

This embodiment allows to exploit the movement generated by the driving device also to move the sectors of said plurality transversely to the moulding direction. To this end, the sectors of said plurality can be moved transversely to the moulding direction by virtue of the interaction with mechanical control devices associated with the other mould part, i.e., the mould part opposite to that moved by the driving device.

In a second aspect of the invention, an apparatus for forming an object is provided, comprising at least one mould which includes a first mould part and a second mould part opposite to each other, a part selected from between the first mould part and the second mould part comprising a plurality of sectors for at least partially forming a lateral surface of the object, the sectors of said plurality delimiting a variable-volume forming region of the mould, the apparatus further comprising a driving device for approaching the first mould part and the second mould part with respect to each other along a moulding direction, so as to bring the first mould part and the second mould part into mutual contact along respective abutment surfaces arranged transversely to the moulding direction, defining between the first mould part and the second mould part a closed forming chamber, and wherein the apparatus further comprises pushing means for moving the sectors transversely to the moulding direction to reduce the volume of the variable-volume forming region.

The apparatus provided by the second aspect of the invention allows to obtain the advantages described above with reference to the method according to the first aspect of the invention.

In a third aspect of the invention, a method is provided for forming an object, comprising the steps of:
providing a mould comprising a first mould part and a second mould part opposite to each other, one part selected from between the first mould part and the second mould part comprising a plurality of sectors for shaping at least a lateral portion of the object;
positioning a dosed amount of mouldable material between the first mould part and the second mould part;
displacing the first mould part and the second mould part towards each other in a moulding direction, until the first mould part and the second mould part are brought into contact, thereby defining a closed forming chamber therebetween,
reducing volume of the closed forming chamber in order to form the object,
   wherein the step of reducing volume of the closed forming chamber comprises moving the sectors of said plurality transversely to the moulding direction after the closed forming chamber has been defined.

In the method according to the third aspect of the invention, before the forming chamber is closed, the sectors can be positioned at a relatively large mutual distance. This also makes it possible to accommodate in the mould dosed amounts of mouldable material having large dimensions with respect to the size of the formed object. It is thus possible to produce, by compression moulding, objects which cannot be obtained with traditional compression moulding machines.

Owing to the sectors which can be displaced transversely to the moulding direction to reduce the volume of the closed forming chamber, the forming chamber can initially have a very different shape than the shape of the finished object. This makes it possible to use dosed amounts of simple shape, which are easy to obtain, as well as to produce objects having a rather complicated geometry.

By providing a forming chamber larger than the object to be produced, the risks that the mouldable material may undesirably interact with the mould are reduced, for example by prematurely adhering to a lateral surface of the forming chamber, which could affect the quality of the object obtained. It is therefore possible to significantly improve the introduction of the dosed amount into the mould.

In an embodiment, when the first mould part and the second mould part are in contact, an abutment element included in the second mould part is abutted against an abutment surface of the sectors, which are included in the first mould part.

In an embodiment, the abutment element is a tubular element surrounding a forming component included in the second mould part.

In an embodiment, after the forming chamber has been closed, it is envisaged to mutually move the forming component and the tubular element to make the forming component penetrate into the first mould part.

In this manner it is possible to shape the mouldable material received in the first mould part.

In an embodiment, the sectors are included in the first mould part and the first mould part further comprises an end-forming element, which defines a forming cavity together with the sectors.

In this manner, it is possible to shape the outer surface of the object which is to be produced in the first mould part.

In particular, the forming cavity may have a lateral surface and a transverse surface arranged at one end of the lateral surface to close the lateral surface at that end.

The lateral surface may be defined entirely by the sectors, in which case the end-forming element defines only the transverse surface of the forming cavity.

In an alternative embodiment, the lateral surface is partly defined by the sectors and partly defined by the end-forming element.

In this case the end-forming element is provided with a recess in which a lateral wall of the object may be partly formed.

The end-forming element also defines the transverse surface of the forming cavity.

This allows to obtain objects having a significant dimension in the moulding direction, as occurs for example in the case of preforms for containers.

In an embodiment, the object to be produced has a hole.

The first mould part has a protruding element projecting from the end-forming element to form the interior of the hole.

In an embodiment, the positioning step comprises arranging the dosed amount in a non-centred position with respect to the sectors, at a side of the protruding element.

When the sectors are moved transversely to the moulding direction to reduce the volume of the closed forming chamber, the dosed amount is flattened around the protruding element, which allows the hole to be formed in the object produced.

This allows to obtain perforated objects without starting from dosed amounts of mouldable material having an annular shape, which are quite difficult to produce.

In a fourth aspect of the invention, an apparatus for forming an object is provided, comprising a mould which includes a first mould part and a second mould part opposite to each other, a part selected from between the first mould part and the second mould part comprising a plurality of sectors for at least partially forming a lateral surface of the object, the apparatus further comprising a driving device for bringing the first mould part and the second mould part into mutual contact, thereby defining between the first mould part and the second mould part a closed forming chamber, and wherein the apparatus further comprises pushing means for moving the sectors transversely to the moulding direction after the forming chamber has been closed, so as to reduce the volume of the closed forming chamber.

As already described with reference to the third aspect of the invention, the apparatus provided by the fourth aspect of the invention also allows to improve the positioning of the dosed amount between the first mould part and the second mould part, as well as to expand the range of objects which can be produced.

In a fifth aspect of the invention, a method is provided for forming an object, comprising the steps of:
providing a mould comprising a first mould part and a second mould part opposite to each other;
positioning a dosed amount of mouldable material between the first mould part and the second mould part;
displacing the first mould part and the second mould part towards each other in a moulding direction, in order to form an object from the dosed amount by means of compression moulding,
   wherein an edge zone of the dosed amount is blocked between the first mould part and the second mould part before starting to deform a central zone of the dosed amount.

This makes it possible to avoid unwanted deformations of the dosed amount during the moulding. For example, it is possible to prevent the dosed amount from shrinking or being arranged non-centred in the mould while being deformed between the first mould part and the second mould part.

In a sixth aspect of the invention, an apparatus is provided for forming an object from a dosed amount of mouldable material, comprising at least one mould which includes a first mould part and a second mould part opposite to each other, a driving device for displacing the first mould part and the second mould part towards each other in a moulding direction, so as to form an object from the dosed amount by compression moulding, wherein a mould part selected from between the first mould part and the second mould part comprises a blocking portion, intended to engage with an edge zone of the dosed amount to press the edge zone against the other mould part selected from between the second mould part and the first mould part, so as to block the dosed amount in contact with the other mould part while the dosed amount is being shaped.

The blocking portion avoids undesired displacements of the dosed amount during the forming.

The invention can be understood more fully and implemented with reference to the attached drawings, which illustrate some versions of its implementation by way of non-limiting example, of which:

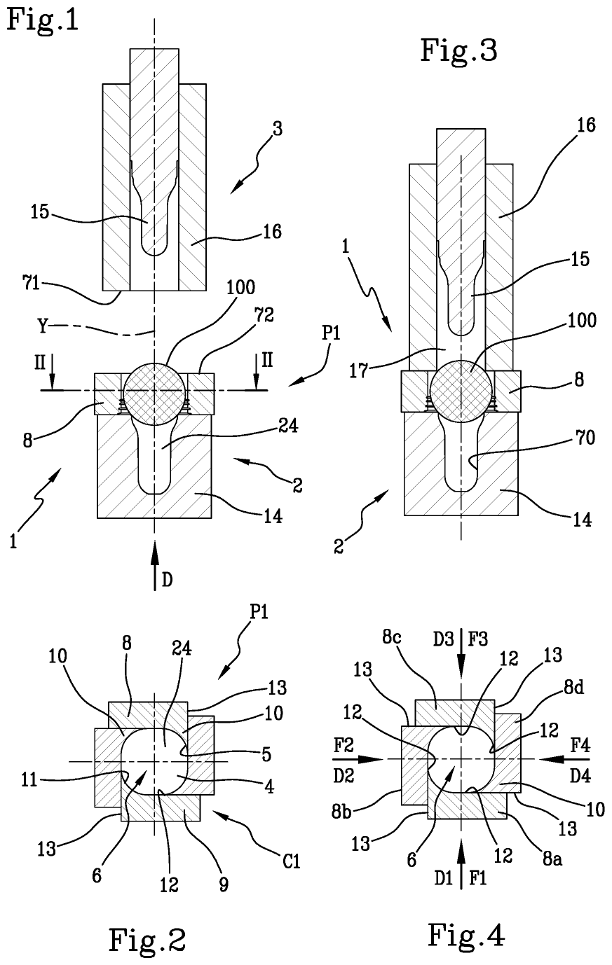

FIG. 1 is a section of a mould for producing an object, taken on a plane containing an axis of the mould;

FIG. 2 is a section taken along the plane II-II of FIG. 1, in which a dosed amount of sliding material has not been shown;

FIG. 3 is a section like in FIG. 1, relating to a step in which a closed forming chamber has been defined in the mould;

FIG. 4 is a section like in FIG. 2, relating to the step of FIG. 3;

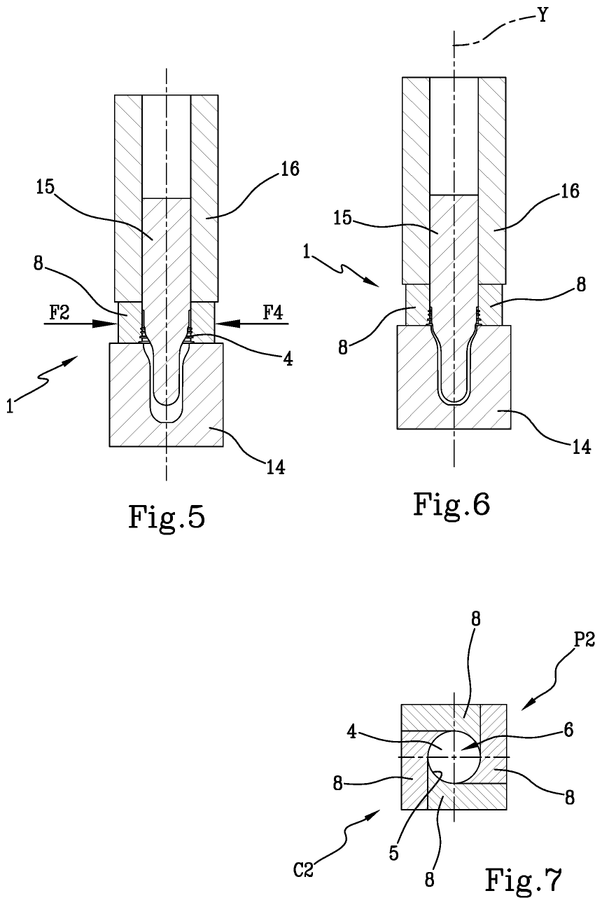

FIG. 5 is a section like in FIG. 1, relating to a step in which a plurality of sectors are mutually approached to reduce the volume of the closed forming chamber;

FIG. 6 is a section like in FIG. 1, relating to an end-forming step;

FIG. 7 is a section like in FIG. 2, relating to the situation of FIG. 6;

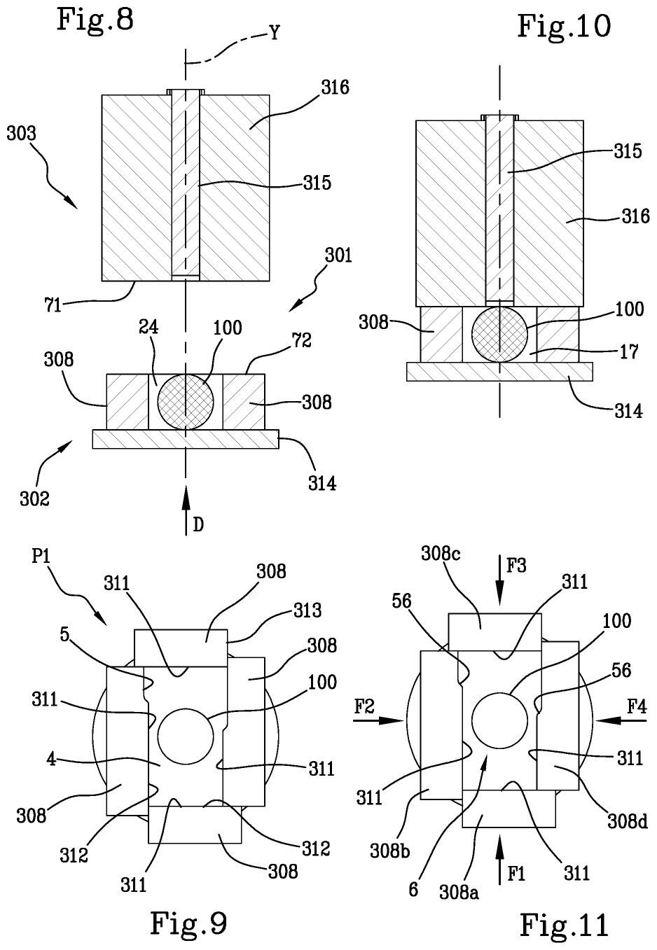

FIG. 8 is a section of a mould for producing an object according to an alternative version, taken on a plane containing an axis of the mould;

FIG. 9 is a view from above of a first part of the mould of FIG. 8;

FIG. 10 is a section like in FIG. 8, relating to a step in which a closed forming chamber has been defined in the mould;

FIG. 11 is a view from above as in FIG. 9, relating to the step of FIG. 10;

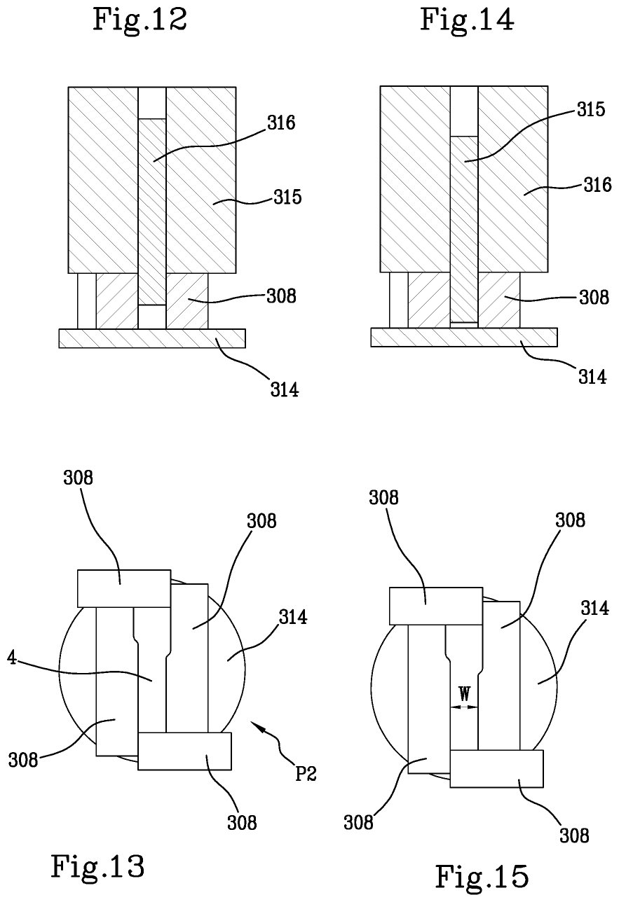

FIG. 12 is a section like in FIG. 8, relating to a step in which a plurality of sectors are mutually approached to reduce the volume of the closed forming chamber;

FIG. 13 is a view from above as in FIG. 9, relating to the step of FIG. 12;

FIG. 14 is a section like in FIG. 8, relating to an end-forming step;

FIG. 15 is a view from above as in FIG. 9, relating to the step of FIG. 14;

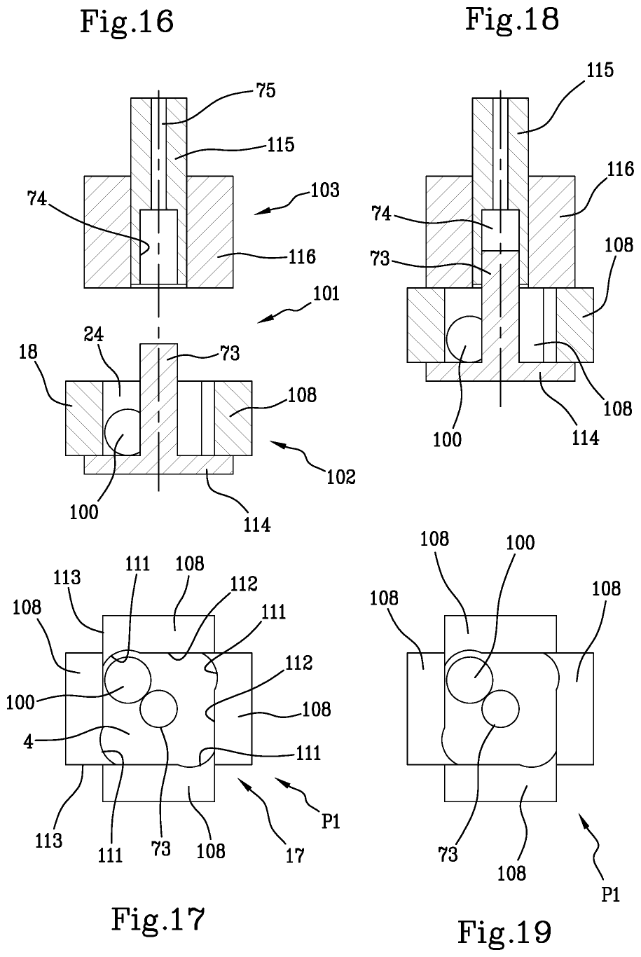

FIG. 16 is a section of a mould for producing an object according to another alternative version, taken on a plane containing an axis of the mould;

FIG. 17 is a view from above of a first part of the mould of FIG. 16;

FIG. 18 is a section like in FIG. 16, relating to a step in which a closed forming chamber has been defined in the mould;

FIG. 19 is a view from above as in FIG. 17, relating to the step of FIG. 18;

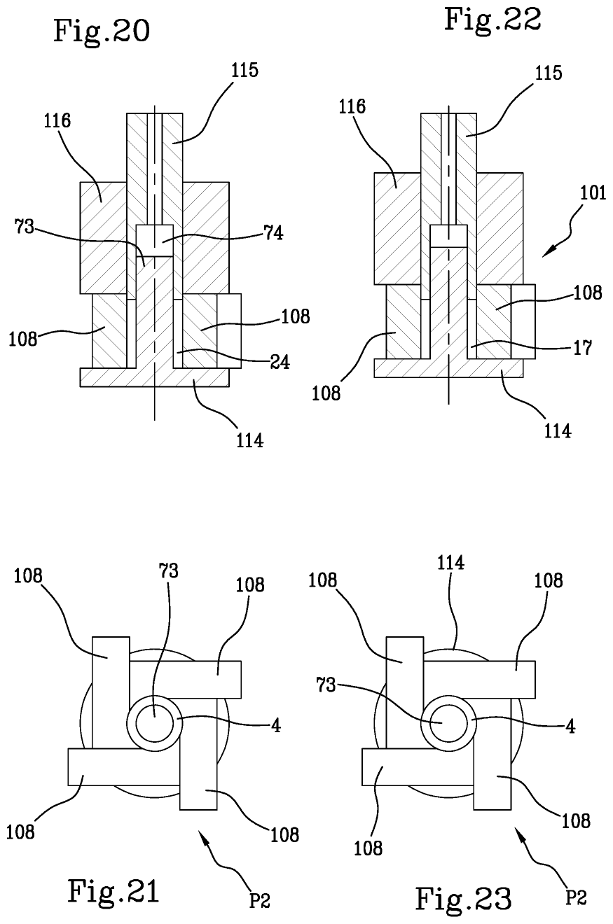

FIG. 20 is a section like in FIG. 16, relating to a step in which a plurality of sectors are mutually approached to reduce the volume of the closed forming chamber;

FIG. 21 is a view from above as in FIG. 17, relating to the step of FIG. 20;

FIG. 22 is a section like in FIG. 16, relating to an end-forming step;

FIG. 23 is a view from above as in FIG. 17, relating to the step of FIG. 22;

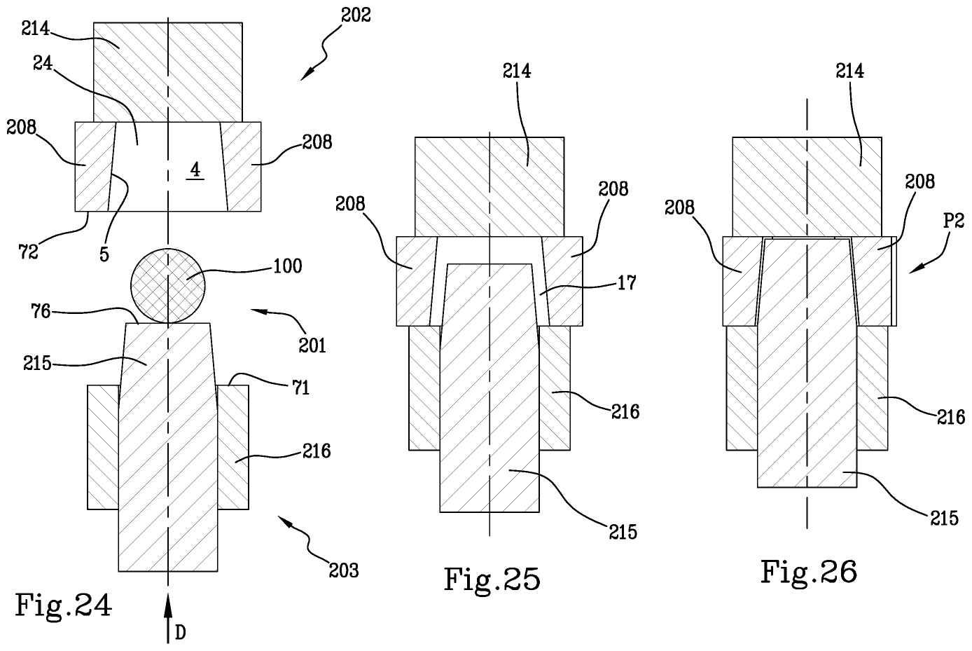

FIGS. 24 to 26 are sections of a mould for producing an object according to a further alternative version, taken on a plane containing an axis of the mould and relating to three successive operating steps of the mould.

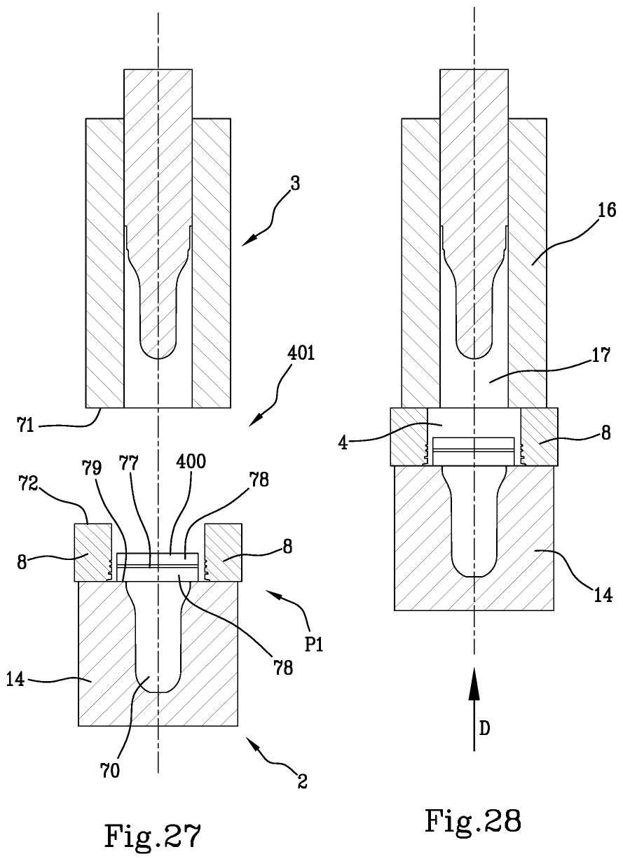

FIG. 27 is a schematic section view like in FIG. 1, relating to a mould in which a multilayer material is processed;

FIG. 28 is a schematic section view like in FIG. 27, relating to a step in which a closed forming chamber has been defined;

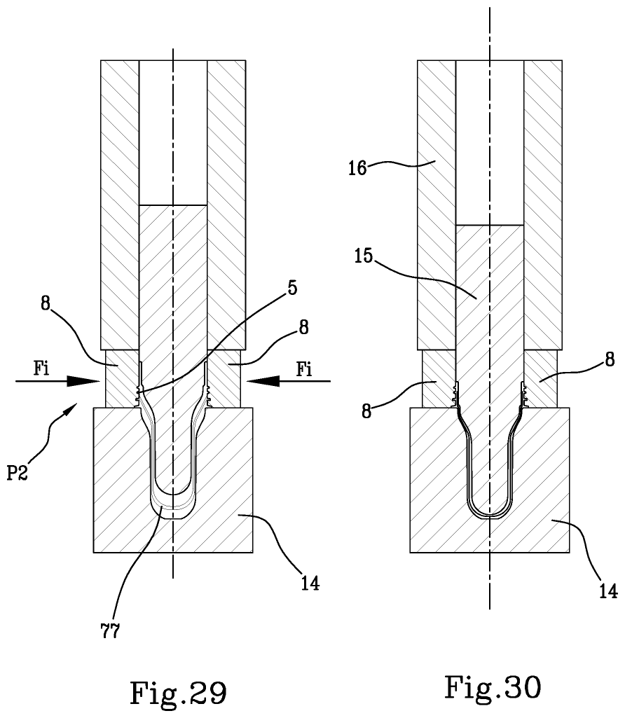

FIG. 29 is a schematic section view like in FIG. 27, relating to a step in which a plurality of sectors are mutually approached to reduce the volume of the closed forming chamber;

FIG. 30 is a schematic section view like in FIG. 27, relating to an end-forming step;

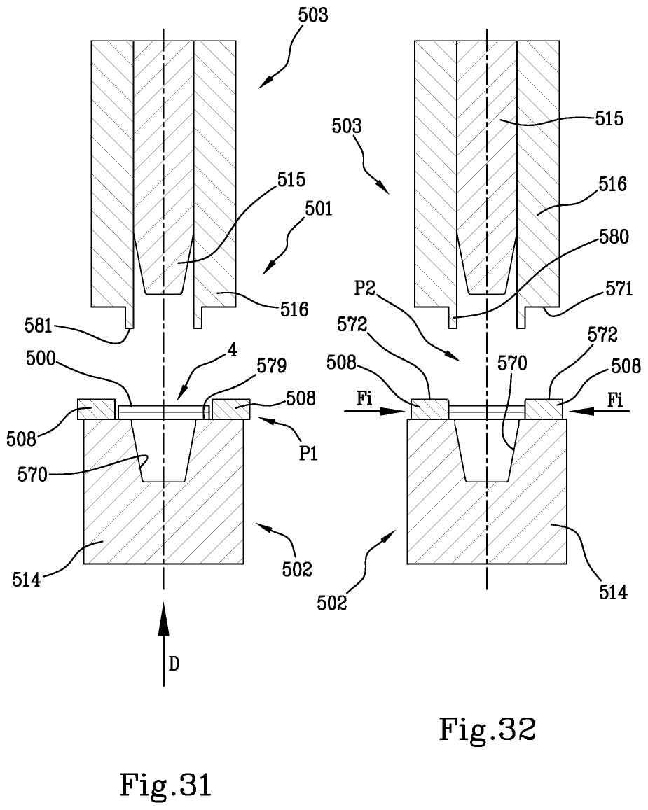

FIG. 31 is a schematic view showing a mould according to an alternative version, in an open configuration;

FIG. 32 is a schematic view of the mould in FIG. 31, relating to a step in which a plurality of sectors are mutually approached to reduce the volume of a variable-volume forming region;

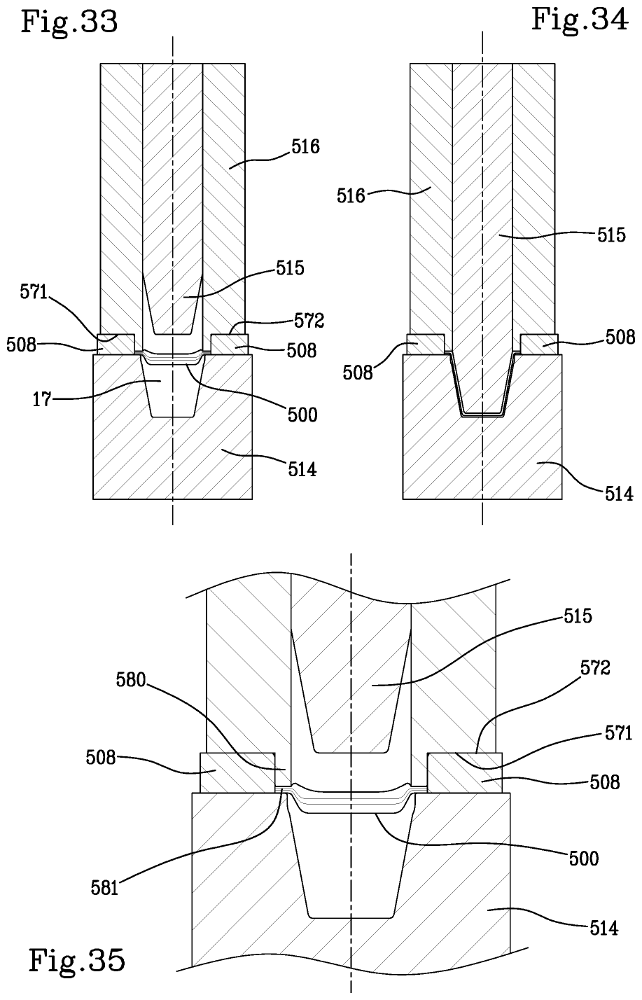

FIG. 33 is a schematic view of the mould in FIG. 31, relating to a step in which a closed forming chamber has been defined;

FIG. 34 is a schematic view of the mould in FIG. 31, relating to an end-forming step;

FIG. 35 is a schematic, enlarged and interrupted view showing a detail of FIG. 34.

FIGS. 1 to 7 schematically show a mould 1 of a moulding apparatus for producing an object by compression moulding a mouldable material.

In the example shown, the mouldable material is a synthetic thermoplastic material, which has been previously extruded in an extrusion device not shown. The extruded material has then been cut to separate doses or dosed amounts 100 therefrom of mouldable material having a predetermined mass. Each dosed amount 100 is intended to originate an object.

In the example shown, the dosed amount 100 has a substantially spherical shape, but other shapes of the dosed amount 100, for example cylindrical or prismatic, are also possible.

The moulding apparatus may comprise a transport device not shown for transporting each dosed amount 100 to a mould 1, after the dosed amounts 100 have been separated from the material exiting the extruder device.

The moulding apparatus may comprise a plurality of moulds 1, for example mounted in a peripheral region of a carousel rotatable about a rotational axis.

In the example shown, the mould 1 is intended to form a preform for a container. The preform is intended to be blow moulded or stretch-blow moulded to obtain a container. The preform comprises a hollow body, having a lateral wall which can be cylindrical or troncoconical. The lateral wall is closed by a transverse wall which may be dome-shaped. The preform further comprises a neck, which may be provided, externally, with fixing means for removably fixing a cap to the neck of the container obtained from the preform. The fixing means may comprise for example one or more threads.

The mould 1 comprises a first mould part 2 and a second mould part 3, facing each other. A driving device not shown is arranged to move the first mould part 2 and the second mould part 3 with respect to each other along a moulding direction D, to mutually approach or alternatively mutually distance the first mould part 2 and the second mould part 3. The driving device may be hydraulic, mechanical or other. One example of a hydraulic-type driving device is a hydraulic actuator. One example of a mechanical-type driving device is a cam device.

The driving device may be associated with the first mould part 2, to bring the first mould part 2 closer to, or alternatively move the first mould part 2 away from, the second mould part 3, which remains fixed along the moulding direction D. Alternatively, the driving device may be associated with the second mould part 3, while the first mould part 2 remains fixed along the moulding direction D. A driving device may also be associated with both the first mould part 2 and the second mould part 3, which in this manner are both movable along the moulding direction D.

Furthermore, the moulding direction D, which in the example shown is vertical, may also be non-vertical, for example horizontal or oblique.

In the example shown, the first mould part 2 is a female mould part, while the second mould part 3 is a male mould part.

In the example shown, the first mould part 2 is arranged below the second mould part 3, but this condition is not necessary and other mutual arrangements of the first mould part 2 and the second mould part 3 are possible.

The first mould part 2 has a forming cavity 24, into which an outer surface of the object may be shaped. The forming cavity 24 may have a Y axis.

In the example shown, the first mould part 2 comprises a plurality of sectors 8 and an end-forming element 14, which interact to define the forming cavity 24.

In particular, the sectors 8 are configured to define a variable-volume forming region 4 of the forming cavity 24, adjacent to the second mould part 3. The end-forming element 14 is arranged to form at least one end wall of the object, which extends transversely to the moulding direction D.

In the example shown, a recess 70 is provided in the end-forming element 14 which is included in the forming cavity 24. The recess 70 defines a portion of the forming cavity 24 with constant volume.

The sectors 8 are interposed between the end-forming element 14 and the second mould part 3.

The sectors 8 and the end-forming element 14 are arranged to shape an outer surface of the object to be produced. More specifically, if the object to be produced is a preform, the sectors 8 are intended to form at least the preform neck from the outside, while the end-forming element 14 is arranged to shape the end wall of the preform from the outside, in addition to the hollow body interposed between the neck and the end wall.

The variable-volume forming region 4 is delimited by a lateral surface 5, which surrounds a central zone 6. The lateral surface 5 is intended to externally shape at least the preform neck.

The sectors 8 are suitable for defining the lateral surface 5 of the variable-volume forming region 4.

In the example shown, four sectors 8 are provided, namely a first sector 8a, a second sector 8b, a third sector 8c and a fourth sector 8d.

Each sector 8 is in contact with two adjacent sectors 8. For example, in the version shown, the first sector 8a is in contact with the second sector 8b and the fourth sector 8d, which are adjacent to the first sector 8a.

In an alternative embodiment not shown, it is also possible to provide a number of sectors 8 other than four.

The sectors 8 may have the same shape.

Each sector 8 comprises a body 9, which may have a substantially parallelepiped shape. A forming appendage 10 projects from the body 9, protruding from the part of the body 9 turned to the central zone 6.

The body 9 is delimited by a forming surface 11, facing the forming region 4 and intended to define, together with the forming surfaces 11 of all the sectors 8, the lateral surface 5 of the variable-volume forming region 4.

In the example shown, the forming surface 11 delimits the forming appendage 10 of the corresponding sector 8.

The forming surface 11 may be curved.

In the example shown, each forming surface 11 has the shape of a cylinder portion, more specifically a quarter of a cylinder, having depressed parts and/or raised parts to originate threads or other fixing means on the preform neck.

Each sector 8 is further delimited by a sliding surface 12, arranged in a position adjacent to the forming surface 11. An adjacent sector 8 is sliding along the sliding surface 12 of a sector 8, as will be better described below. The sliding surface 12 is shaped as a continuation of the forming surface 11. The sliding surface 12 may be seamlessly contiguous with the forming surface 11. The sliding surface 12 may be tangent to the forming surface 11. In the example shown, each sliding surface 12 has a substantially flat shape.

Each sector 8 also has a contact surface 13 arranged on the opposite side of the forming surface 11 with respect to the sliding surface 12, i.e., on the part of the forming appendage 10 facing away from the forming cavity 24. The contact surface 13 of a sector 8 is intended to slide along the sliding surface 12 of an adjacent sector 8. In the example shown, the contact surface 13 has a substantially flat shape.

The moulding apparatus further comprises a plurality of pushing devices, not shown, arranged to apply a force on corresponding sectors 8 so as to push each sector 8 towards the central zone 6 of the variable-volume forming region 4.

Each pushing device may comprise an actuator, for example hydraulic, or electric, or pneumatic. Alternatively, each pushing device may comprise a mechanical actuator, for example of the cam type.

The pushing devices allow the sectors 8 to be moved between a first position P1, shown in FIGS. 1 and 2, and a second position P2, shown in FIGS. 6 and 7. In the first position P1, the sectors 8 define an enlarged configuration C1 of the variable-volume forming region 4. In the second position P2, the sectors 8 define a final configuration C2 of the variable-volume forming region 4.

In the final configuration C2, the variable-volume forming region 4 has a shape corresponding to the outer shape of the preform neck. In the enlarged configuration C1, the variable-volume forming region 4 instead has larger dimensions than the dimensions of the preform neck, i.e., larger dimensions with respect to the dimensions which the variable-volume forming region 4 has in the final configuration C2. To switch from the enlarged configuration C1 to the final configuration C2, the volume of the variable-volume forming region 4 decreases.

It is possible to provide a number of pushing devices equal to the number of sectors 8, i.e., a pushing device associated with each sector 8, so that each sector 8 is moved by the corresponding pushing device.

For example, as shown in FIG. 4, a first pushing device, not shown, may be configured to apply a first force F1 to the first sector 8a, directed along a first direction D1. The first force F1 is such as to move the first sector 8a towards the central zone 6 of the variable-volume forming region 4, in particular by reducing the distance between the sliding surface 12 of the first sector 8a and the Y axis.

As the first sector 8a moves towards the moulding axis Y, the contact surface 13 of the first sector 8a slides along the sliding surface 12 of the second sector 8b. The first force F1, as well as the corresponding first direction D1, is in fact directed parallel to the contact surface 13 of the first sector 8a and the sliding surface 12 of the second sector 8b.

Furthermore, a portion of the sliding surface 12 of the first sector 8a which is in contact with the fourth sector 8d pushes on the fourth sector 8d (in particular on the contact surface 13 thereof) by moving the forming appendage 10 of the fourth sector 8d towards the moulding axis Y, i.e., towards the central zone 6 of the variable-volume forming region 4. This occurs because the sliding surface 12 of the first sector 8a and the contact surface 13 of the fourth sector 8d are arranged transversely, in particular perpendicular, to the first direction D1 of the first force F1.

At the same time, the second pushing device acts on the second sector 8b, applying a second force F2 on the latter, directed along a second direction D2, which is arranged transversely to the first direction D1.

In the example shown, the second direction D2 is perpendicular to the first direction D1.

The second sector 8b is thus pushed towards the central zone 6 of the variable-volume forming region 4, i.e., towards the Y axis. While this occurs, the contact surface 13 of the second sector 8b slides along the sliding surface 12 of the third sector 8c.

The second sector 8b is in contact with the first sector 8a because the contact surface 13 of the first sector 8a is in contact with the sliding surface 12 of the second sector 8b. These two surfaces are arranged transversely, in particular perpendicular, to the second direction D2. Under the action of the second pushing device, the second sector 8b therefore transmits the second force F2 to the first sector 8a.

A resulting force is thus applied on the first sector 8a, given by the combination of the first force F1 and the second force F2, which pushes the forming surface 11 (in particular the forming appendage 10) of the first sector 8a towards the Y axis, along a trajectory which is arranged obliquely with respect to the first direction D1 and the second direction D2. For example, the forming surface 11 of the first sector 8a may move towards the Y axis along a direction inclined by 45° with respect to the first direction D1 and the second direction D2.

The same situation occurs with reference to the other pairs of sectors 8. For example, a third force F3 directed along a third direction D3 is applied to the third sector 8c thanks to the third pushing device. The third direction D3 may be the same as and opposite to the first direction D1.

The third force F3 pushes the third sector 8c towards the central zone 6 of the variable-volume forming region 4, while the contact surface 13 of the third sector 8c slides along the sliding surface 12 of the fourth sector 8d. At the same time, the third force F3 is transmitted on the second sector 8b, which is in contact with the third sector 8c, because the sliding surface 12 of the third sector 8c touches the contact surface 13 of the second sector 8b. A resulting force given by the combination of the second force F2 and the third force F3 is applied to the second sector 8b.

The fourth pushing device exerts a fourth force F4 on the fourth sector 8d, directed along a fourth direction D4 which, in the example shown, is the same as and opposite to the second direction D2. The fourth direction D4 is thus arranged transversely, in particular perpendicular, to the first direction D1 and the third direction D3.

The fourth sector 8d thus moves towards the Y axis, sliding along the first sector 8a along a direction parallel to the fourth direction D4. At the same time, the fourth sector 8d transmits the fourth force F4 to the third sector 8c. A resulting force, given by the combination of the third force F3 and the fourth force F4, directed along a direction inclined with respect to the third direction D3 and the fourth direction D4, then acts on the latter.

The first force F1 from the first sector 8a is also transmitted on the fourth sector 8d, so that the forming appendage 10 of the fourth sector 8d moves towards the Y axis under the combined action of the first force F1 and the fourth force F4.

In general, a force directed towards the Y axis is applied to each of the sectors 8, which pushes the forming appendage 10 of the corresponding sector 8 towards the central zone 6 of the variable-volume forming region 4. At the same time, the contact surface 13 of the considered sector 8, which can be parallel to the force applied on that sector, slides along the sliding surface 12 of an adjacent sector 8. The sliding surface 12 of the sector 8 considered, which is arranged transversely (for example perpendicular) to the contact surface 13 of a further adjacent sector 8, transmits to the further adjacent sector 8 the force applied on the sector 8 considered, so as to push the forming appendage 10 of the further adjacent sector towards the Y axis. Two forces are therefore exerted on each sector 8, one of which is due to the pushing device associated with the sector 8 considered, while the other is applied by a sector 8 adjacent to the one considered. The result of these two forces pushes the forming surface 11 of the sector 8 considered towards the Y axis, along a trajectory which can be radial with respect to the Y axis. In this manner, the sectors 8 allow to reduce the volume of the variable-volume forming region 4 in which the mouldable material has already been positioned.

In the example described above, a pushing device is provided for each sector 8. In an alternative version not shown, the number of pushing devices may be different, in particular smaller, than the number of sectors 8.

For example, in an embodiment not shown, only two pushing devices may be provided, acting on the first sector 8a and the second sector 8b respectively, while the third sector 8c and the fourth sector 8d are arranged in a fixed position.

The sectors 8 are slidable in contact with the end-forming element 14 to move from the first position P1 to the second position P2.

The second mould part 3 comprises a male forming component 15, shaped like a punch, which extends along the Y axis and is arranged to penetrate the variable-volume forming region 4 so as to shape the object to be produced from the inside. In other words, the male forming component 15 allows the mouldable material to be compressed along a direction parallel to the Y axis.

An abutment element 16, with respect to which the male forming component may slide, is arranged outside the male forming component 15. The abutment element 16 is arranged to abut against the first mould part 2, for the reasons which will be set out below. The abutment element 16 may be shaped as a tubular element, i.e., having a hole within which the male forming component 15 is housed.

In an alternative embodiment not shown, the male forming component 15 is arranged inside the abutment element 16, with one or more components interposing between the male forming component 15 and the abutment element 16.

The abutment element 16 is delimited by a front surface 71, which extends transversely, in particular perpendicular, to the Y axis. The front surface 71 faces the sectors 8, more particularly an abutment surface 72 which delimits the sectors 8.

During operation, the mould 1 is initially in an open position, i.e. the first mould part 2 and the second mould part 3 are initially in a spaced position, shown in FIG. 1, in which the abutment element 16 is detached from the first mould part 2. In particular, the front surface 71 of the tubular element 16 is not in contact with the abutment surface 72 of the sectors 8. The forming cavity 24 is open at the top and a transport device not shown may be introduced between the first mould part 2 and the second mould part 3 to deposit a dosed amount 100 of mouldable material in the forming cavity 24. The male forming component 15 is in a retracted position with respect to the abutment element 16 and does not protrude from the abutment element 16.

The sectors 8 are arranged in the first position P1, in which they define the enlarged configuration C1 of the variable-volume forming region 4. The sectors 8 therefore delimit a variable-volume forming region 4 having a relatively large volume, which is able to receive a dosed amount 100 of mouldable material having a significant dimension, measured transversely to the moulding direction D. In particular, the dosed amount 100 may have a transverse dimension (for example a diameter, in the case of a spherical dosed amount 100) greater than the outer diameter of the preform neck to be formed by the dosed amount 100.

In the example shown, the dosed amount 100 is received between the sectors 8 and initially rests on an upper zone of the end-forming element 14. The dosed amount 100 is therefore initially spaced from a bottom of the recess 70.

Furthermore, the dosed amount 100 has a transverse dimension (e.g., a diameter, in the case of a spherical dosed amount 100), smaller than the corresponding transverse dimension of the variable-volume forming region 4, when the latter is in the enlarged configuration C1. Accordingly, when the dosed amount 100 is deposited in the first mould part 2, the dosed amount 100 is spaced from the sectors, in particular from the lateral surface 5 of the variable-volume forming region 4.

The first mould part 2 and the second mould part 3 are brought closer together until the abutment element 16 abuts against the sectors 8, as shown in FIG. 3. In the example shown, the driving device not shown acting on the first mould part 2 displaces the first mould part 2 towards the second mould part 3, bringing the abutment surface 72 of the sectors 8 into contact with the abutment element 16, in particular with the front surface 71 of the latter. The front surface 71 thus acts as a further abutment surface against which the abutment surface 72 contacts.

When the sectors 8 and the second mould part 3 come into mutual contact, i.e., when the respective abutment surfaces 71, 72 of the first mould part 2 and the second mould part 3 touch, a closed forming chamber 17 is defined between the first mould part 2 and the second mould part 3, having a much greater volume than the final volume of the object to be produced, i.e., the preform, as shown in FIG. 3. More specifically, the forming chamber 17 is defined between the end-forming element 14, the sectors 8, the abutment element 16 and the male forming component 15.

The male forming component 15 is still in the retracted position, where it does not protrude from the abutment element 16.

The sectors 8 are still in the first position P1, as shown in FIG. 4. Consequently, the dosed amount 100 has not yet undergone significant deformation.

The driving device continues to push the first mould part 2 towards the male forming component 15. In this way, the abutment element 16, which is now in contact with the first mould part 2, is also retracted, for example by compressing one or more springs not shown.

The male forming component 15 may be arranged in a fixed position in the moulding direction D. Accordingly, as the abutment element 16 continues to be displaced backwards (i.e., upwards in FIG. 5) from the first mould part 2, the male forming component 15 begins to protrude from the abutment element 16 and penetrate the forming cavity 24. Initially, the male forming component 15 penetrates the variable-volume forming region 4, after which it also enters the recess 70, as shown in FIG. 5. The mouldable material is thus gradually compressed along the moulding direction D, i.e., parallel to the Y axis.

At the same time the sectors 8, which were initially in the first position P1, begin to approach each other, according to the methods described above, as shown in FIG. 5. In particular, each sector 8, under the action of the force applied thereto by the corresponding pushing device and that applied thereto by an adjacent sector 8, moves in motion such that the corresponding forming surface 11 approaches the Y axis, displacing itself for example along a trajectory, which can be linear, for example inclined by 45° with respect to the directions of the two forces applied on the sector 8 considered.

The volume of the forming chamber 17 gradually decreases and the mouldable material, which is not shown in FIGS. 5 to 7, is gradually shaped between the first mould part 2 and the second mould part 3.

The first mould part 2 continues to be pushed towards the male forming component 15, and the sectors 8 continue to be moved towards the Y axis, until the condition shown in FIGS. 6 and 7 is reached. In this condition, the sectors 8 have reached the second position P2, and the male forming component 15 is at a distance, from a bottom region of the recess 70, which is substantially equal to the thickness of the end wall of the preform.

The preform is thus obtained from the dosed amount 100. The latter remains in the mould 1, and is cooled thanks to cooling means not shown, for a sufficient time to reach a degree of hardening which allows it to be handled without damage. Subsequently, with a sequence of steps opposite to that described above, the mould 1 is opened, the preform is extracted and a new forming cycle may be started.

As is clear from the comparison between FIGS. 4 and 7, not only the volume, but also the shape of the variable-volume forming region 4 changes from the enlarged configuration C1 to the final configuration C2.

More specifically, in the example shown, in the enlarged configuration C1 the lateral surface 5 of the variable-volume forming region 4 is defined by a plurality of curved portions, corresponding to the forming surfaces 11, between which respective flat portions, corresponding to the sliding surfaces 12, are interposed.

In the final configuration C2, each forming surface 11 is contiguous with the forming surface 11 of an adjacent sector 8, and the sliding surfaces 12 are no longer facing the forming region 4, as each sliding surface 12 is covered, or hidden, by the forming appendage 10 of an adjacent sector.

The mould 1 allows to obtain objects of good quality, having a curved lateral wall, for example circular.

FIGS. 8 to 15 show a mould 301 according to an alternative version, which allows to obtain objects having a non-circular shape in plan view, for example a polygonal shape. In the example shown, in particular, the mould 301 allows to produce a spoon, shaped like a scoop, in particular for ice cream, yoghurt or other creamy products. However, a mould similar to the mould 301 may also be used to produce objects other than spoons.

The parts of the mould 301 similar to the parts of the mould 1 described above will be indicated with the same reference numerals already used for FIGS. 1 to 7 and will not be further described in detail.

The mould 301 is also particularly suitable for producing objects in synthetic polymeric material from a dosed amount 100 of synthetic polymeric material. The dosed amount 100 was separated from a continuous extrudate outflowing from an extrusion device and subsequently transported towards the mould 301 via a transport device not shown.

In the example shown, the dosed amount 100 has a substantially spherical shape, but other shapes are possible for the dosed amount 100.

The dosed amount 100 has a relatively large dimension with respect to the dimensions of the object to be obtained. In the example shown, the dosed amount 100 has a diameter greater than a transverse dimension W of the object to be formed, shown in FIG. 15.

The mould 301 also comprises a first mould part 302 and a second mould part 303, movable with respect to one another along a moulding direction D, which in the example shown is vertical. The first mould part 302 and the second mould part 303 are similar to the first mould part 2 and the second mould part 3 described above.

In particular, in the example shown, the first mould part 302 is a female mould part and is arranged below the second mould part 303.

The first mould part 302 comprises a plurality of sectors 308, adapted to define the lateral surface 5 which delimits the variable-volume forming region 4.

In the example shown, the sectors 308 have different shapes from each other.

In particular, in the example shown there are four sectors 308, but the number of sectors 308 may be different from four.

In the example shown, a first sector 308a, a second sector 308b, a third sector 308c and a fourth sector 308d may be identified, as shown in FIG. 11.

Each sector 308 is delimited by a forming surface 311 facing the variable-volume forming region 4.

In the example shown, the first sector 308a and the third sector 308c have respective, substantially flat forming surfaces 311. The second sector 308b and the fourth sector 308d, on the other hand, have forming surfaces 311 which are not flat, but have, for example, a step 56, to define an enlarged portion of the spoon to be formed. The enlarged portion is a withdrawal portion for withdrawing a substance, for example food, from a container.

Each sector 308 also has a sliding surface 312, arranged adjacent to the forming surface 311 of that sector. The sliding surface 312 may be a continuation of the forming surface 311. The sliding surface 312 faces the variable-volume forming region 4.

Each sector also has a contact surface 313, adapted to slide along the sliding surface 312 of an adjacent sector.

The sliding surface 312 and the contact surface 313 may both be flat. The contact surface 313 of a sector 308 is arranged transversely, in particular perpendicular, to the sliding surface 312 of the same sector 308. The forming surface 311 is interposed between the contact surface 313 and the sliding surface 312 of a sector 308. In this manner, an end zone of the forming surface 311 is adjacent to the sliding surface 312, while a further end zone of the forming surface 311, opposite the above-mentioned end zone, is adjacent to the contact surface 313.

A plurality of pushing devices not shown is further provided for applying respective forces to the sectors 308 directed towards a central zone 6 of the variable-volume forming region 4.

In particular, the pushing devices are configured to apply on the first sector 308a, on the second sector 308b, on the third sector 308c and on the fourth sector 308d respectively a first force F1, a second force F2, a third force F3 and a fourth force F4, as already described above with reference to FIGS. 1 to 7.

Each sector 308 is displaceable towards the central zone 6 of the variable-volume forming region 4 due to the resulting force of two distinct forces. One of these forces is applied to the sector 308 by the corresponding pushing device, while the other force, which is directed transversely (in particular perpendicular) to the previous one, is transmitted to the sector 308 by the adjacent sector.

Under the action of the force applied by the respective pushing device to each sector 308, the latter moves towards the central zone 6 so that the contact surface 313 of the sector 308 considered slides along the sliding surface 312 of an adjacent sector. At the same time, the adjacent sector 308 transmits to the sector 308 considered a force as a result of which the sliding surface 312 of the sector 308 considered flows along the contact surface 313 of a further sector 308 adjacent to the sector 308 considered.

The first mould part 302 further comprises an end-forming element 314, in contact with which the sectors 308 may slide. The end-forming element 314 delimits the variable-volume forming region 4 transversely to the moulding direction D, from the side opposite the second mould part 303.

The end-forming element 314 defines, together with the sectors 308, the forming cavity 24, which in the example shown is open upwards.

In the example shown, the end-forming element 314 is of the slab type.

Unlike what occurred in the mould 1 shown in FIGS. 1 to 7, the end-forming element 314 is not provided with any recess in which the mouldable material can be shaped.

Thus, in the mould 301 of FIGS. 8 to 15, the forming cavity 24 has a lateral surface, which extends around the Y axis and is defined by the sectors 308. The forming cavity 24 further has a transverse surface defined by the end-forming element 314. The transverse surface of the forming cavity 24 may be flat.

The second mould part 303 comprises a forming component 315 adapted to penetrate the forming cavity 24 to shape the desired object by applying a compression action to the mouldable material in a direction parallel to the Y axis, i.e., along the moulding direction D.

The forming component 315 is arranged inside an abutment element 316 which, in the example shown, is provided with a central hole in which the forming component 315 is housed. The abutment element 316 is adapted to abut against the sectors 308 to close a forming chamber 17 defined between the first mould part 302 and the second mould part 303.

The forming component 315 is slidably movable, along the moulding direction D, with respect to the abutment element 316.

During operation, the mould 301 is initially in an open position, i.e., the first mould part 302 and the second mould part 303 are initially in a spaced position, as shown in FIG. 8. The front surface 71 of the abutment element 316 is spaced from the abutment surface 72 of the sectors 308. A transport device not shown may therefore deposit a dosed amount 100 of mouldable material in the forming cavity 24.

The sectors 308 are in the first position P1, as shown in FIG. 9. A variable-volume forming region 4 is therefore defined between the sectors 308, having dimensions larger than the size of the dosed amount 100, so that the dosed amount 100 may be received in the variable-volume forming region 4 without interfering with the sectors 308.

A driving device moves the first mould part 302 and the second mould part 303 towards each other in the moulding direction D, so that the first mould part 302 and the second mould part 303 come into contact to define the closed forming chamber 17 therebetween. In particular, the first mould part 302 and the second mould part 303 come into contact with each other when the abutment surface 72 touches the front surface 71, which can be considered as a further abutment surface.

In the example shown, the driving device is associated with the first mould part 302 and pushes the latter towards the second mould part 303. When the abutment surface 72 of the sectors 308 is in contact with the front surface 71 of the abutment element 316, a closed forming chamber 17 is defined between the end-forming element 314, the sectors 308, the abutment element 316 and the forming component 315. The latter is still in a retracted position in which it does not protrude from the abutment element 316 towards the end-forming element 314, as shown in FIG. 10.

The sectors 308 are still in the first position P1 and have not yet begun to significantly interact with the dosed amount 100, as shown in FIG. 11.

The pushing devices not shown now act on the sectors 308 to bring the sectors 308 into the second position P2, as shown in FIGS. 12 and 13. This causes a progressive decrease in the volume of the variable-volume forming region 4 and thus of the closed forming chamber 17.

While the sectors 308 are brought to the second position P2, the driving device continues to move the first mould part 302 towards the second mould part 303. The sectors 308, pushed towards the second mould part 303 by the driving device, cause the abutment element 316 to retract with respect to the forming component 315. The forming component 315 thus begins to protrude from the abutment element 316 and can penetrate the forming cavity 24 to push the mouldable material towards the end-forming element 314, in the moulding direction D. The mouldable material is progressively forced to fill the entire closed forming chamber 17 to originate the desired object. It is noted that the forming component 315 may penetrate the forming cavity 24 by sliding in contact with the sectors 308 to form a flat object, i.e., without the mouldable material interposing between the forming component 315 and the sectors 308.

The driving device continues to push the first mould part 302 towards the second mould part 303, while the forming component 315 increasingly protrudes from the abutment element 316. In this manner, the forming component 315 continues to approach the end-forming element 314 until it reaches a distance, from the end-forming element 314, equal to the thickness of the object to be obtained, as shown in FIG. 14. The mould 301 remains in this condition for a sufficient time for the object to become sufficiently rigid in order to be handled without damage, after which the first mould part 302 and the second mould part 303 move away from each other and the object is removed to allow a new dosed amount 100 to be introduced into the variable-volume forming region 4.

This allows to obtain, by compression moulding, also objects having a relatively small dimension transversely to the moulding direction D, which however require relatively large dosed amounts, i.e., having an initial transverse dimension greater than the corresponding dimension of the finished object.

FIGS. 16 to 23 show a mould 101 according to an alternative version, which allows to obtain perforated objects, in particular objects having a through hole.

The mould 101 comprises a first mould part 102 and a second mould part 103, facing each other and movable with respect to one another in a moulding direction D, similarly to what is described for the first mould part 2 and the second mould part 3 shown in FIGS. 1 to 7.

The first mould part 102 comprises a plurality of sectors 108, adapted to define the lateral wall 5 of the variable-volume forming region 4. In the example shown, there are four sectors 108, having the same shape as each other.

The sectors 108 are functionally similar to the sectors 8 described with reference to FIGS. 1 to 7, although the shape thereof is different from that of the sectors 8, as it is specific to the particular object to be produced.

In particular, each sector 108 comprises a forming surface 111, which in the example shown has the shape of a cylinder portion. The forming surfaces 111 are intended to cooperate with each other to shape a lateral wall of the object from the outside. Each sector 108 further has a sliding surface 112, which may be flat. The sliding surface 112 of a sector 108 is adjacent to the forming surface 111.

When the sectors 108 are in the first position P1, to define an enlarged configuration C1 of the forming cavity 24, the forming surface 111 and the sliding surface 112 of each sector 108 delimit the lateral surface 5 of the variable-volume forming region 4.

Each sector 108 also has a contact surface 113, which is intended to slide along the sliding surface 112 of an adjacent sector 108, when the sectors 108 move to reduce the volume of the variable-volume forming region 4, as already described with reference to FIGS. 1 to 7.

The contact surface 113, which may be flat, does not face the variable-volume forming region 4, as it faces the sliding surface 112 of an adjacent sector 108.

The sectors 108 are movable between the first position P1, shown in FIGS. 17 and 19, and the second position P2, shown in FIGS. 21 and 23, by means of pushing devices not shown, as previously described with reference to FIGS. 1 to 7.

The first mould part 102 further comprises an end-forming element 114, which delimits the variable-volume forming region 4 transversely to the moulding direction D, from the side opposite to the second mould part 103. The sectors 108 are arranged in contact with the end-forming element 114 and are slidable relative to the latter.

A core 73 projects from the end-forming element 114, protruding towards the second mould part 103. The core 73 is intended to shape the interior of the hole of the object to be produced. In the example shown, the core 73 has a cylindrical shape.

The core 73 may have a dimension, along the moulding direction D, greater than the corresponding dimension of the sectors 108. In this case, the core 73 protrudes towards the second mould part 103 with respect to the sectors 108.

A forming cavity 24 having an annular shape is defined between the core 73 and the sectors 108. The forming cavity 24 is open at the top.

The second mould part 103 comprises an abutment element 116, adapted to abut against the sectors 108 to close the forming chamber 24. A forming component 115 is housed inside the abutment element 116, adapted to form an edge zone of the object, opposite to that which will be formed in contact with the end-forming element 114.

The forming component 115 has a guide hole 74, arranged to receive a portion of the core 73 associated with the end-forming element 114. The guide hole 74 may in particular engage in a shaped coupling with the core 73.

A through hole 75 may be provided in the forming component 115. The through hole 75 may extend between the guide hole 74 and a surface of the forming component 115 farther from the forming cavity 24. The through hole may for example serve as a vent hole for the outflow of air present between the core 73 and the forming component 115.

The forming component 115 is slidable with respect to the abutment element 116 parallel to the moulding direction D.

During operation, the mould 101 is initially open. The first mould part 102 and the second mould part 103 are located in a spaced position, shown in FIG. 16. In this position, a transport device not shown may be inserted between the first mould part 102 and the second mould part 103, which transports a dosed amount 100 separated from the continuous extrudate exiting the extrusion device and depositing it in the forming cavity 24.

The sectors 108 are in the first position P1, as shown in FIG. 17. The volume of the variable-volume forming region 4 is therefore maximum, so that the variable-volume forming region 4 can easily accommodate the dosed amount 100.

In particular, the distance between the core 73 and the lateral surface 5 of the variable-volume forming region 4 is, at least at some points, greater than the transverse dimension of the dosed amount 100. In the example shown, the variable-volume forming region 4 has, in plan, approximately the shape of a quadrilateral (in particular a square) with rounded vertices. Each side of the quadrilateral is defined by the sliding surface 112 and the forming surface 111 of a sector 108. The rounded vertices of the quadrilateral correspond to the forming surfaces 111 which are arranged near the vertices of the quadrilateral.

The distance between the vertex zones of the quadrilateral and the core 73 is greater than the transverse dimension of the dosed amount 100. As shown in FIG. 17, a dosed amount 100 of mouldable material may then be positioned in a non-centred position in the variable-volume forming region 4, close to an edge zone of the variable-volume forming region 4.

In the example shown, the distance between the lateral surface 5 of the variable-volume forming region 4 and the core 73 is in fact greater than a transverse dimension of the dosed amount 100, in particular of the diameter of the latter, at least along a diagonal of the quadrilateral defined, in plan, by the lateral surface 5.

After the dosed amount 100 has been received in the variable-volume forming region 4, the first mould part 102 and the second mould part 103 are moved towards each other until they come into contact with each other. In particular, in the example shown, a driving device moves the first mould part 102 towards the second mould part 103 in the moulding direction D, as shown in FIG. 16. The sectors 108 are thus brought into contact with the abutment element 116, as shown in FIG. 18. The forming component 115 is housed inside the abutment element 116 and, in the example shown, does not yet protrude, in this step, from the abutment element 116 towards the first mould part 102.

The core 73 has already partially penetrated the guide hole 74, engaging in a shaped coupling with the latter. This allows the first mould part 102 to be kept more effectively guided than the second mould part 103.

The sectors 108 are still in the first position P1, as shown in FIG. 19.

When the first mould part 102 and the second mould part 103 come into contact with each other, a closed forming chamber 17 is defined between the first mould part 102 and the second mould part 103, shown in FIG. 18. The forming chamber 17 is defined, at an end thereof (which in the example shown is a lower end) by the end-forming element 114. The forming chamber 17 is further defined, at the opposite end thereof, by the abutment element 116 and the forming component 115. Finally, the forming chamber 17 is defined laterally, by the sectors 108 (outside) and the core 73 (inside). Subsequently, the sectors 108 are moved transversely to the moulding direction D, for example according to the methods previously described with reference to FIGS. 1 to 7, and approach the core 73. The dosed amount 100 thus begins to be deformed between the sectors 108 and the core 73 to fill the forming chamber 17.

As the sectors 108 approach the core 73, the volume of the variable-volume forming region 4 decreases, as does the volume of the closed forming chamber 17.

Furthermore, the first mould part 102 and the second mould part 103 continue to be moved towards each other. More in detail, the driving device continues to move the first mould part 102 towards the second mould part 103. The abutment element 116, which is abutted against the sectors 108, is thus moved in the moulding direction D along with the first mould part 102 (upwards in the example shown). The forming component 115 instead remains in a fixed position along the moulding direction D. Thus, the core 73 penetrates deeper into the guide hole 74 of the forming component 115. The latter begins to enter the forming cavity 24, i.e., to be interposed between the sectors 108 and the core 73, to shape an end zone of the object opposite the further end zone which is shaped by the portion of the end-forming element 114 from which the core 73 protrudes.

This step is shown in FIGS. 20 and 21.

In one version, the sectors 108 are first brought to the second position P2, after which the forming component 115 begins to protrude from the abutment element 116 to be interposed between the sectors 108 and the core 73. However, this condition is not mandatory, and the forming component 115 could begin to be interposed between the sectors 108 and the core 73 even before the sectors 108 have reached the second position P2.

The driving device continues to move the first mould part 102, which pushes the abutment element 116, towards the forming component 115. The latter thus penetrates further into the variable-volume forming region 4, until it reaches a final forming position in which the forming chamber 17 has a shape corresponding to the object to be produced, shown in FIG. 22. During this step, the volume of the forming chamber 17, which was previously closed, is further reduced. In particular, while the volume of the forming chamber 17 is reduced, the forming component 115 compresses the mouldable material in the moulding direction D, while the sectors 108 compress the mouldable material transversely to the moulding direction D.

The mould 101 remains in the position shown in FIGS. 22 and 23 for sufficient time to consolidate the object. Subsequently, the mould 101 is returned to the open position and the formed object is extracted from the mould 101 to allow a new object to be formed.

A tubular object, provided with a through hole originating from the core 73, was thus obtained.

This was made not from a dosed amount of mouldable material having an annular shape, which is rather complicated to produce and manipulate, but from a dosed amount of mouldable material having a full shape, in particular spherical or cylindrical, which may be produced and transported relatively easily.

In an alternative version not shown, the mould 101 may be used to produce not only perforated objects, but also hollow objects having a non-through indentation, such as container preforms or heads for crushable tube containers, having a closed end. In this case, the first mould part 102 comprises the core 73 which, however, in the final forming position, is not in contact with the second mould part 103, so as to form a closed end of the object.

FIGS. 24 to 26 show a mould 201 according to an alternative version. The mould 201 comprises a first mould part 202 and a second mould part 203, which can be moved towards each other or alternatively moved away from each other along a moulding direction D. This may occur thanks to a driving device not shown, similar to that described above with reference to the versions already described. In the example shown, the driving device is connected to the second mould part 203, which is thus movable along the moulding direction D, while the first mould part 202 remains fixed in that direction.

The first mould part 202 is a female mould part, while the second mould part 203 is a male mould part. Unlike what occurred in the versions described with reference to FIGS. 1 to 23, the first mould part 202 is positioned above the second mould part 203.

The mould 201 is adapted to form a concave object, for example a container such as a capsule for coffee or for other substances, starting from a dosed amount 100 of mouldable material, which in the example shown is spherical in shape. However, other forms are possible for the dosed amount 100.

The dose 100 may be cut from a continuous extrudate outflowing from an extrusion device not shown and transported to the mould 201 by a transport device not shown.

The first mould part 202 comprises a plurality of sectors 208, adapted to define the lateral surface 5 of the variable-volume forming region 4. The sectors 208 may have a shape similar to the sectors 8 shown in FIGS. 1 to 17. The sectors 208 may be movable between a first position P1, shown in FIG. 24, and a second position P2, shown in FIG. 26, by respective pushing devices, similarly to what is described with reference to the preceding Figures.

The first mould part 202 further comprises an end-forming element 214, which delimits the variable-volume forming region 4 transversely to the moulding direction D, from the side opposite to the second mould part 203. The forming cavity 24 is defined between the sectors 208 and the end-forming element 214, which in the example shown faces downwards.

The second mould part 203 comprises a male forming component 215, delimited at the upper end thereof by a support surface 76 on which a dosed amount 100 of mouldable material may be rested.

The second mould part 203 further comprises an abutment element 216, surrounding the male forming component 215. The abutment element 216 may have a tubular shape. The abutment element 216 is adapted to abut against the sectors 208 to close a forming chamber 17 defined between the first mould part 202 and the second mould part 203. In particular, the abutment element 216 is delimited, transversely to the moulding direction D, by the front surface 71, adapted to abut against the abutment surface 72 of the sectors 208.

The front surface 71 and the abutment surface 72 extend transversely, in particular perpendicular, to the moulding direction D. In the shown example, the front surface 71 and the abutment surface 72 are substantially flat.

During operation, the mould 201 is initially in an open position, i.e. the first mould part 202 and the second mould part 203 are initially in the spaced position shown in FIG. 24, in which between the first mould part 202 and the second mould part 203 it is possible to introduce a transport device transporting a dosed amount 100 of mouldable material. The sectors 208 are located in the first position P1, where the volume of the variable-volume forming region 4 is maximum.

The transport device deposits a dosed amount 100 into the mould 201, in particular by positioning the dosed amount 100 on the support surface 76 of the male forming component 215. The latter protrudes from the abutment element 216 towards the first mould part 202.

Subsequently, the driving device begins to move the second mould part 203 towards the first mould part 202. The male forming component 215 approaches the forming cavity 24 and, at a certain point, begins to penetrate into the latter, to compress the mouldable material in the moulding direction D. The abutment element 216 then abuts against the sectors 208. When this occurs, a forming chamber 17 is defined between the first mould part 202 and the second mould part 203 which is closed, as shown in FIG. 25. The forming chamber 17 is in particular delimited by the end-forming element 214, the sectors 208, the male forming element 215 and the abutment element 216. The sectors 208 are still in the first position P1.

After the forming chamber 17 has been closed, the abutment element 216 remains in a fixed position along the moulding direction D, as it abuts against the sectors 208, which in turn are in contact with the end-forming element 214.

The sectors 208 are moved transversely to the moulding direction D, so as to approach the male forming component 215 and reach the second position P2, shown in FIG. 26. In this manner the volume of the variable-volume forming region 4 is progressively reduced.

The driving device further moves the male forming element 215 towards the end-forming element 214, until the male forming element 215 reaches a distance, from the end-forming element 214, equal to the thickness of a transverse wall of the object to be produced. At this point, the mould 201 is in a final forming position. The first mould part 202 and the second mould part 203 remain in this position for a sufficient time for the formed object to be adequately cooled, after which the mould 201 opens and the object may be removed.

FIGS. 27 to 30 show a mould 401 completely analogous to the mould 1 shown in FIGS. 1 to 7, used to produce an object, particularly a preform, by compression moulding, starting from a dosed amount 400 of mouldable material having a geometry different from the geometries of the dosed amounts 100 shown so far.

More specifically, the dosed amount 400 has a flat geometry, with a plan shape that may be square, rectangular, cylindrical, or polygonal. The height of the dosed amount 400, i.e., its dimension along the moulding direction D, may be smaller than the dimensions of the dosed amount 400 transversely to the moulding direction D.

The dose 400 may be formed from a single material or, as in the shown example, have a multilayer structure.

In particular, the dosed amount 400 may comprise an intermediate layer 77 interposed between two outer layers 78. The intermediate layer 77 may comprise a material having barrier properties, for example to oxygen, and/or gases, and/or light, and/or flavourings. Alternatively, the intermediate layer 77 may be at least in part made of a recycled polymeric material.

The outer layers 78 may be formed by a material having the purpose of conferring the desired mechanical and aesthetic properties to the object. Between the outer layers 78 and the intermediate layer 77, one or more layers of compatibilizing material may be interposed, adapted to improve the adhesion between the intermediate layer 77 and the outer layers 78.

The mould 401 is initially in an open position, as shown in FIG. 27, in which the first mould part 2 is spaced from the second mould part 3. The sectors 8 are in the first position P1, corresponding to the enlarged configuration C1 of the variable-volume forming region 4. The dosed amount 400 is now inserted into the mould 401, in particular by delivering it to the first mould part 2 so that the dosed amount 400 is supported on a support surface 79 of the end-forming element 14, in a position spaced from the bottom of the recess 70. More specifically, the support surface 79 has an annular shape and an edge area of the dosed amount 400 can be supported thereon. The support surface 79 is surrounded by the sectors 8. In the shown example, the support surface 79 has an area which decreases when the sectors 8 pass from the first position P1 to the second position P2. In the second position P2, the support surface 79 is intended to form an inner surface of a ring which projects radially from the neck of the preform.

The dosed amount 400 is thus surrounded by the sectors 8 which, being still arranged in the first position P1, delimit a relatively wide variable-volume forming region 4, in which the dosed amount 400 may be placed without the latter touching the sectors 8. More specifically, despite having greater transverse dimensions than the transverse dimension of the recess 70, the dosed amount 400 is introduced into the mould without being substantially deformed, since the sectors 8, in the first position P1, delimit a variable-volume forming region 4 whose transverse dimensions are greater than those of the dosed amount 400.

The dosed amount 400 is introduced into the first mould part 2, for example by supporting it on the shoulder 79, with an orientation in which the intermediate layer 77 is arranged transversely, in particular perpendicular, to the moulding direction D.

The first mould part 2 and the second mould part 3 are now moved towards each other to define, between the first mould part 2 and the second mould part 3, a closed forming chamber 17, shown in FIG. 28. The closed forming chamber 17 is defined when the sectors 8 abut against the abutment element 16. In particular, the abutment surface 72 of the sectors 8 abuts against the further abutment surface or front surface 71 of the abutment element 16.

At this point, as shown in FIG. 29, the sectors 8 are moved to the second position P2, by applying to the sectors 8 respective forces Fi directed transversely, in particular perpendicular, to the moulding direction D. The forces Fi can be applied as described with reference to FIGS. 1 to 7. It is also possible to use sectors 8 having a different geometry from those shown in FIGS. 1 to 7, and which pass from the first position P1 to the second position P2 along different trajectories.

In any case, the forces Fi move the sectors 8 along respective directions arranged transversely to the moulding direction D. In the shown example, the sectors 8 are moved perpendicular to the moulding direction D with respect to the end-forming element 14.

In the second position P2, the sectors 8 delimit the lateral surface 5 of the variable-volume forming region 4, the lateral surface 5 having the shape of a portion of the outer surface of the object to be obtained, specifically of the neck of the preform.

As the sectors 8 pass from the first position P1 to the second position P2, the first mould part 2 and the second mould part 3 continue to move towards each other. In particular, the first mould part 2 moves in the moulding direction D towards the male forming component 15. The abutment element 16, which is in contact with the sectors 8, is also moved in the moulding direction D with respect to the male forming component 15. The male forming component 15 thus penetrates between the sectors 8 and subsequently into the recess 70, internally shaping the object.

FIG. 29 shows a situation in which the dosed amount 400, deformed by the male forming component, has reached the bottom of the recess 70 and is gradually originating the preform. During the deformation of the dosed amount 400, the intermediate layer 77 is also deformed and distributed substantially throughout the body of the moulded object. In this way, the properties conferred by the intermediate layer 77 are substantially uniform throughout the object.

The male forming component 15 continues to penetrate the recess 70, as a result of the upwards movement (i.e., towards the male forming component 50) of the first mould part 2 and the abutment element 16, until the preform has reached its definitive shape, as shown in FIG. 30. When this occurs, a maximum compressive force is applied to the first mould part 2 to keep the mould 401 in a forming position and obtain the desired object.

After the preform has cooled sufficiently within the mould 401, the mould is returned to the open position and the preform is extracted from the mould to be further processed.

In the examples described so far, the sectors were moved transversely to the moulding direction D, to be brought into the second position P2, only after the closed forming chamber 17 had been defined, i.e., after the first mould part and the second mould part had come into mutual contact.

However, this condition is not necessary and it is possible to start moving the sectors to reduce the volume of the variable-volume forming region 4 even when the first mould part and the second mould part are still spaced apart from each other.

An example of the above is depicted in FIGS. 31 to 34, showing a mould 501 according to an alternative version, where the sectors reach the second position P2 before closing the mould.

In the shown example, the mould 501 is configured to produce capsules for coffee or for other substances intended for the preparation of beverages or foods by passing an extraction fluid through the capsule. It is understood that a mould similar to that of FIGS. 31 to 34 could however be used to produce other objects, especially concave objects such as caps, containers, preforms for containers and the like.

The mould 501 also comprises a first mould part 502 and a second mould part 503, movable with respect to one another along a moulding direction D, which in the example shown is vertical.

In the shown example, the first mould part 502 is arranged below the second mould part 503, but this condition is not necessary.

The first mould part 502 is a female mould part, while the second mould part 503 is a male mould part.

The first mould part 502 may comprise an end-forming element 514 in which a recess 570 is formed. The recess 570 is arranged to form from the outside a bottom wall, for example substantially flat, and a lateral wall, for example truncoconical, of the capsule.

The first mould part 502 further comprises a plurality of sectors 508, for example analogous to the sectors 8 described above. In more detail, the sectors 508 are slidable in contact with an upper surface of the end-forming element 514, transversely (in particular perpendicular) to the moulding direction D.

The end-forming element 514 is delimited, in its own upper portion, by a support surface 579 adapted to supportingly receive a dosed amount 500 of mouldable material. The support surface 579 may be flat and may be arranged transversely, in particular perpendicular, to the moulding direction D.

The support surface 579 surrounds the recess 570 and is interposed between the sectors 508. The support surface 579 has an annular shape.

The sectors 508 are movable between the first position P1 and the second position P2, for example in manners similar to those described for the previous versions, thanks to pushing means not shown.

When the sectors 508 move from the first position P1 to the second position P2, the volume of the variable-volume forming region 4, defined between the sectors 508, decreases. At the same time, the area of the support surface 579 is reduced. In the second position P2, the support surface 579 is configured to form a lower surface of a capsule flange. The flange projects outwards from an upper region of a capsule body.

The sectors 508 are configured to form a lateral surface of the flange, i.e., a flange surface which extends about an axis of the capsule and may be parallel to such an axis.

The second mould part 503 comprises a male forming component 515 adapted to penetrate the recess 570 to shape the bottom wall and the lateral wall of the capsule from the inside. The male forming component 515 allows the mouldable material to be compressed in a direction parallel to the moulding direction D.

The second mould part 503 further comprises an abutment element 516 adapted to come into contact with the first mould part 502, specifically with the sectors 508, to close the mould 501, i.e., to define within the mould 501 a closed forming chamber 17.

More specifically, each sector 508 is delimited by an abutment surface 572 arranged in a position facing the abutment element 516.

The abutment surface 572 is adapted to abut against a further abutment surface 571 (or front surface), which delimits the abutment element 516 in a position facing the first mould part 502.

The abutment surface 572 and the further abutment surface 571 extend transversely, in particular perpendicular, to the moulding direction D.

The abutment element 516 surrounds the male forming component 515. In a version not shown, additional components may be present between the abutment element 516 and the male forming component 515.

The abutment element 516 comprises a blocking portion 580 which protrudes from the further abutment surface 571 towards the first mould part 502. The blocking portion 580 has an annular geometry and may be for example shaped like a circular crown.

The blocking portion 580 may be delimited by a blocking surface 581, for example flat, which extends transversely, in particular perpendicular, to the moulding direction D.

The blocking portion 580 is adapted to contact the dosed amount 500 to push it against the end-forming element 514, in particular against the support surface 579. In more detail, the blocking portion 580 is intended to block an edge zone of the dosed amount 500 against the end-forming element 514, so that the dosed amount 500 remains in a centred position with respect to the recess 570 even when the male forming component 515 deforms the dosed amount 500.

During operation, the mould 501 is initially in an open position, shown in FIG. 31. The first mould part 502 is spaced from the second mould part 503, so that the dosed amount 500 of polymeric material can be inserted into the mould 501. The dosed amount 500 may for example be released into the mould 501 by a transport element not shown, temporarily interposed between the first mould part 502 and the second mould part 503.

In the shown example, the dosed amount 500 has a multilayer structure and comprises an intermediate layer interposed between at least two outer layers of polymeric material, as already described with reference to the dosed amount 400 shown in FIGS. 27 and 28.

The dosed amount 500 is supported on the support surface 579, so that only the edge zone thereof is in contact with the first mould part 502, while a central area of the dosed amount 500 is initially spaced from the bottom of the recess 570 and does not touch the first mould part 502.

When the dosed amount is placed on the support area 579, the intermediate layer is arranged transversely, in particular perpendicular, to the moulding direction D.

In a version not shown, the mould 501 may also be used in combination with doses having a monolayer structure, i.e., formed from a single synthetic polymeric material.

The sectors 508 are arranged in the first position P1 corresponding to the enlarged configuration C1 of the variable-volume forming region 4. In the first position P1, the variable-volume forming region 4 has greater transverse dimensions (i.e., measured transversely to the moulding direction D) than the transverse dimensions of the dosed amount 500. Consequently, the dosed amount 500 is not prematurely deformed by the sectors 508 when it is introduced into the mould 501 by supporting it on the support surface 579.

Subsequently, the pushing means apply on the sectors 508 respective forces Fi to bring the sectors 508 closer to a central zone of the variable-volume forming region 4, until the sectors 508 reach the second position P2, as shown in FIG. 32. The forces Fi can be applied in the manners shown in FIGS. 1 to 7, or in other manners, for example by exerting on each sector 508 a single force directed towards the central zone of the variable-volume forming region 4.

The sectors 508 thus begin to deform the edge zone of the dosed amount 500.

When the sectors 508 reach the second position P2, the first mould part 502 is still spaced from the second mould part 503. To be precise, the first mould part 502 and the second mould part 503 have not yet begun to move towards each other.

Subsequently, the first mould part 502 and the second mould part 503 begin to move closer towards each other. In the shown example, this occurs by moving the first mould part 502 along the moulding direction D and holding the second mould part 503 in a fixed position along the moulding direction D.

This leads to a situation, shown in FIG. 33, in which the abutment surface 572 of the sectors 508 is in contact with the further abutment surface 571 of the abutment element 516.

At this point, a closed forming chamber 17 is defined between the first mould part 502 and the second mould part 503.

The blocking portion 580 has been inserted between the sectors 508 so that the blocking surface 579 acts on the edge zone of the dosed amount 500, crushing such an edge zone and pressing it against the end-forming element 514.

In practice, the blocking portion 580 exerts a sort of “stapling” action on the edge zone of the dosed amount 500, which thus remains firmly blocked between the blocking portion 580 and the end-forming element 514 even when the dosed amount 500 is deformed by the male forming component 515.

The first mould part 502, together with the abutment element 516 against which the first mould part 502 abuts, continues to move with respect to the male forming component 515, in particular by approaching such a component. Since the male forming component 515 is arranged in a fixed position along the moulding direction D, the male forming component 515 penetrates the recess 570, deforming the dosed amount also in the central zone of the latter, until reaching the end-of-forming position shown in FIG. 34. In this position, the capsule has been fully formed and, after having been sufficiently cooled, it can be extracted from the mould 501.

By clamping the edge zone of the dosed amount 500 between the blocking portion 580 and the first mould part 502, it is possible to maintain the dosed amount 500 in a centred position with respect to the recess 570 even when a central zone of the dosed amount 500 is deformed by the male forming component 515. Furthermore, if the dosed amount 500 has a multilayer structure, it is possible to prevent the intermediate layer of the dosed amount, flowing outwards of the dosed amount in the edge zone, from emerging on an outer surface of the formed object and being visible on such an object.

It is noted that the blocking portion 580 which blocks the edge zone of the dosed amount 500 against the first mould part 503 can also be used in moulds in which the sectors 508 are absent, i.e., in moulds in which in the first mould part 503 a forming cavity is made having fixed dimensions transversely to the moulding direction D.

It is noted that, not only in the mould version described with reference to FIGS. 31 to 35, but also in moulds of the type shown in FIGS. 1 to 30, it is possible to start moving the sectors transversely to the moulding direction D to bring the sectors into the second position P2 even before the forming chamber has been closed, i.e., even before the closed forming chamber 17 has been defined between the first mould part and the second mould part. If the sectors are moved before closing the forming chamber, the second position P2 can be reached before or after the closed forming chamber 17 has been defined.

In all the mould versions referred to, the sectors may be moved between the first position and the second position due to the interaction between the mould part in which they are included and the other mould part. For example, each sector could be provided with a roller or a set of levers which interact with the mould part opposite to that in which the sector is included in order to displace the sector from the first position to the second position. The sectors associated with a mould part could therefore be moved between the first position and the second position on the other mould part. In one version, the sectors could be moved from the first position to the second position also in a non-axially symmetrical way, for example following trajectories not oriented at 45° with respect to the directions of the forces applied, or having different lengths from each other.

The sectors could further be moved between the first position and the second position also with different movement methods than those described thus far, for example due to the effect of simple actuators which move the corresponding sector in the direction of the applied force.

In the above description, reference has always been made to sectors included in the female mould part. In an alternative version not shown, the sectors delimiting the variable-volume forming region could be included in the male mould part.

In the foregoing description, reference was always made to a dosed amount of mouldable material, in particular synthetic polymeric material, obtained by cutting a continuous extrudate outflowing from an extrusion device. However, it is also possible to use a dosed amount of synthetic polymeric material obtained in other ways, for example by cutting a sheet or film of synthetic polymeric material.

Alternatively, the mouldable material forming the dosed amount may be a material at least a part of which is derived from natural fibres, for example cellulose, in the form of powder, granules, or supplemented with particular liquid substances, for example to obtain a sort of paste, or in the form of wadding, or preform, or other element cut from a film.

In this case, the starting material has a relatively low density and needs to be pressed with a high degree of compaction to provide a finished object of good quality. This means that the initial volume of the material at least a part of which is derived from natural fibres is much greater than the volume of the finished object. Accordingly, it is useful to have a mould comprising the sectors described above, movable between a first position in which the variable-volume forming region is relatively large, and therefore can house a low-density material which occupies a lot of space, and a second position in which the material has been compacted and has reached the shape and size of the finished object.

In conclusion,

The dosed amount can be pre-packaged, i.e., prepared separately from the mould (for example by cutting, pressing or other) and inserted into the open mould.

The method and apparatus described herein make it possible to obtain an object of good quality starting from a dosed amount having a dimension, in particular measured transversely to the moulding direction D, greater than a corresponding transverse dimension of the moulded object.

In summary, in a first version of a first aspect of the invention, a method for forming an object is provided, comprising the steps of:
providing a mould (1; 101; 201; 301; 401; 501) comprising a first mould part (2; 102; 202; 302; 502) and a second mould part (3; 103; 203; 303; 503) opposite to each other, a part selected from between the first mould part (2; 102; 202; 302; 502) and the second mould part (3; 103; 203; 303; 503) comprising a plurality of sectors (8; 108; 208; 308; 508) for shaping at least a lateral portion of the object, the sectors (8; 108; 208; 308; 508) of said plurality delimiting a variable-volume forming region (4) of the mould;
positioning a dosed amount (100; 400; 500) of mouldable material between the first mould part (2; 102; 202; 302; 502) and the second mould part (3; 103; 203; 303; 503);
displacing the first mould part (2; 102; 202; 302; 502) and the second mould part (3; 103; 203; 303; 503) towards each other in a moulding direction (D), to define between the first mould part (2; 102; 202; 302; 502) and the second mould part (3; 103; 203; 303; 503) a closed forming chamber (17),
   the method further comprising the step of moving the sectors (8; 108; 208; 308; 508) transversely to the moulding direction (D) to reduce the volume of the variable-volume forming region (4).

The dosed amount (100; 400; 500) of mouldable material may be positioned between the first mould part (2; 102; 202; 302; 502) and the second mould part (3; 103; 203; 303; 503) while the mould is in an open position.

The closed forming chamber (17) can be defined by bringing into contact respective abutment surfaces (71, 72; 571, 572) of the first mould part (2; 102; 202; 302; 502) and the second mould part (3; 103; 203; 303; 503), the abutment surfaces (71, 72; 571, 572) extending transversely to the moulding direction (D).

In a second version, a method according to the first version is provided, wherein the sectors (8; 108; 208; 308; 508) are movable transversely to the moulding direction (D) between an enlarged configuration (C1) and a final configuration (C2), the dosed amount (100; 400; 500) being released between the first mould part (2; 102; 202; 302; 502) and the second mould part (3; 103; 203; 303; 503) while the dosed amount (100; 400; 500) has transverse dimensions, measured perpendicular to the moulding direction (D), which are smaller than the transverse dimensions of the variable-volume forming region (4) in the enlarged configuration (C1).

In a third version, a method according to the first or second version is provided, wherein the step of moving the sectors (8; 108; 208; 308; 508) transversely to the moulding direction (D) starts before the closed forming chamber (7) has been defined.

In a fourth version, a method is provided according to one of the versions from the first to the third, wherein the step of moving the sectors (8; 108; 208; 308; 508) transversely to the moulding direction (D) starts after the closed forming chamber (7) has been defined.

In a fifth version, a method is provided according to the first or second version, wherein the step of moving the sectors (8; 108; 208; 308; 508) transversely to the moulding direction (D) starts after the closed forming chamber (7) has been defined.

In a sixth version, a method is provided according to one of the versions from the first to the fifth, wherein the step of displacing the first mould part (2; 102; 202; 302; 502) and the second mould part (3; 103; 203; 303; 503) towards each other in the moulding direction (D) occurs by means of a driving device which moves at least one mould part selected from between the first mould part (2; 102; 202; 302; 502) and the second mould part (3; 103; 203; 303; 503) towards the other mould part selected from between the second mould part (3; 103; 203; 303; 503) and the first mould part (2; 102; 202; 302; 502), the sectors (8; 108; 208; 308; 508) being included in the mould part moved by the driving device.

In a seventh version, a method is provided according to one of the versions from the first to the sixth, wherein the closed forming chamber (17) is defined by bringing into mutual contact the sectors (8; 108; 208; 308; 508) and an abutment element (16; 116; 216; 316; 516) of the mould part opposite to the sectors and selected from between the second mould part (3; 103; 203; 303; 503) and the first mould part (2; 102; 202; 302; 502) the mould part facing the sectors (8; 108; 208; 308; 508), further comprising a forming component (15; 115; 215; 315; 515) at least partially surrounded by the abutment element (16; 116; 216; 316; 516).

In an eighth version, a method according to the seventh version is provided, wherein said respective abutment surfaces (71, 72; 571, 572) comprise an abutment surface (72; 572) and a further abutment surface (71; 571) of the abutment element (16; 116; 216; 316; 516), said abutment surface (72; 572) and said further abutment surface (71; 571) being brought into mutual contact to close the forming chamber (17).

In a ninth version, a method is provided according to the seventh or the eighth version, wherein after the sectors (8; 108; 208; 308; 508) and the abutment element (16; 116; 216; 316; 516) have been brought into mutual contact, at least said part selected from between the first mould part (2; 102; 202; 302; 502) and the second mould part (3; 103; 203; 303; 503) is moved further in the moulding direction (D), so that the forming component (15; 115; 215; 315; 515) penetrates between the sectors (8; 108; 208; 308; 508) of said plurality to form the object.

In a tenth version, a method is provided according to one of the versions from the seventh to the ninth, wherein the forming component (15; 115; 215; 315; 515) is a male forming component (15; 215; 515), the mouldable material flowing between the sectors (8; 108; 208; 308; 508) and the male forming component (15; 215; 515) to originate a lateral wall of the object.

In an eleventh version, a method according to the tenth version is provided, wherein the male forming component (215) is included in the second mould part (3; 103; 203; 303; 503) and is positioned below the first mould part (2; 102; 302: 402; 502), and wherein the dosed amount (100) is positioned on a support surface (76) delimiting an upper end of the male forming component (215).

In a twelfth version, a method is provided according to one of the versions from the seventh to the tenth, wherein, in a final forming position, the forming component (315) delimits the closed forming chamber (17) transversely to the moulding direction (D) and is in contact with the sectors (8; 108; 208; 308; 508) to prevent the mouldable material from flowing between the forming component (315) and the sectors (8; 108; 208; 308; 508).

In a thirteenth version, a method according to one of the previous versions is provided, wherein an edge zone of the dosed amount (500) is blocked between the first mould part (2; 102; 302: 402; 502) and the second mould part (3; 103; 203; 303; 503) before starting to deform a central zone of the dosed amount (500).

In a fourteenth version, a method according to the thirteenth version is provided, when in the thirteenth version the features of the seventh version are included, wherein the sectors (8; 108; 208; 308; 508) are included in the first mould part (2; 102; 302: 402; 502), and wherein the edge zone of the dosed amount (500) is supported on the first mould part (2; 102; 302: 402; 502) and blocked between the first mould part (2; 102; 302: 402; 502) and the second mould part (3; 103; 203; 303; 503) before the forming component (15; 115; 215; 315; 515) starts to interact with the central zone of the dosed amount (500).

In a fifteenth version, a method is provided according to the thirteenth version, when the thirteenth version includes the features of the seventh version, or according to the fourteenth version, wherein the sectors (8; 108; 208; 308; 508) are included in the first mould part (2; 102; 302: 402; 502), and wherein the edge zone of the dosed amount (500) is blocked between the first mould part (2; 102; 302: 402; 502) and the second mould part (3; 103; 203; 303; 503), clamping the dosed amount (500) between a blocking portion (580) which projects from the abutment element (16; 116; 216; 316; 516) and a support surface (79; 579) of the first mould part (2; 102; 302: 402; 502), the sectors (8; 108; 208; 308; 508) being slidable along the support surface (79; 579) to reduce the volume of the variable-volume forming region (4).

In a sixteenth version, a method is provided according to the fifteenth version, wherein the blocking portion (580) interposes between the sectors (8; 108; 208; 308; 508) to clamp the dosed amount (500) against the support surface (79; 579).

In a seventeenth version, a method is provided according to one of the previous versions, wherein the sectors (8; 108; 208; 308; 508) are movable between a first position (P1) in which the volume of the variable-volume forming region (4) is maximum, and a second position (P2), in which the volume of the variable-volume forming region (4) is minimum, and in which the dosed amount (100; 400; 500) is positioned between the first mould part (2; 102; 202; 302; 502) and the second mould part (3; 103; 203; 303; 503) while the sectors (8; 108; 208; 308; 508) are in the first position (P1).

In an eighteenth version, a method is provided according to one of the previous versions, wherein the first mould part (2; 102; 202; 302; 502) comprises the sectors (8; 108; 208; 308; 508) and an end-forming element (14; 114; 214; 314; 514) delimiting the closed forming chamber (17) transversely to the moulding direction (D) at the opposite side with respect to the second mould part (3; 103; 203; 303; 503).

In a nineteenth version, a method is provided according to the eighteenth version, wherein the sectors (8; 108; 208; 308; 508) are slidable transversely to the moulding direction (D) in contact with the end-forming element (14; 114; 214; 314; 514) to decrease the volume of the closed forming region (4).

In a twentieth version, a method is provided according to the eighteenth or the nineteenth version, wherein the first mould part (2; 102; 202; 302; 502) has a forming cavity (24), the forming cavity (24) comprising the variable-volume forming region (4) delimited by the sectors (8; 508) and a recess (70) made in the end-forming element (14; 514).

In a twenty-first version, a method is provided according to the eighteenth or the nineteenth version, wherein the first mould part (2; 102; 202; 302; 502) comprises a protruding core (73) protruding from the end-forming element (14; 114; 214; 314; 514) towards the second mould part (3; 103; 203; 303; 503), and wherein the dosed amount (100; 400; 500) is positioned in the first mould part (2; 102; 202; 302; 402) in a non-centred position with respect to the sectors (8; 108; 208; 308; 508), at a side of the protruding core (73), so that the mouldable material flows between the sectors (8; 108; 208; 308; 508) and the protruding core (73) to originate an object having a hole or a hollow.

In a twenty-second version, a method is provided according to the twenty-first version, when the eighteenth version comprises the features of the seventh version, wherein the protruding core (73) protrudes from the sectors (8; 108; 208; 308; 508) towards the second mould part (3; 103; 203; 303; 503) to engage in a guide hole (74) made in the forming component (115).

In a twenty-third version, a method is provided according to the previous versions, wherein in each sector (8; 108; 208; 308; 508) moves transversely to the moulding direction (D) to reduce the volume of the variable-volume forming region (4) under the action of a resulting force given by the combination of a first force (F1) applied to said sector (8; 108; 208; 308; 508) by a pushing device and a second force (F2) applied to said sector (8; 108; 208; 308; 508) by an adjacent sector (8; 108; 208; 308; 508) of said plurality.

In a twenty-fourth version, a method is provided according to one of the previous versions, and further comprising extruding the mouldable material, generating a continuous extrudate of mouldable material, separating a dosed amount (100; 400; 500) from the continuous extrudate, transporting the dosed amount (100; 400; 500) into the mould (1; 101; 201; 301; 401; 501).

In a twenty-fifth version, a method is provided according to the twenty-fourth version, wherein the continuous extrudate comprises at least two layers (78, 79) of polymeric material, the dosed amount (400; 500) being introduced into the mould (401; 501) such that each of said two layers (78, 79) extends transversely, preferably substantially perpendicular, to the moulding direction (D).

In a first version of a second aspect of the invention, an apparatus is provided for forming an object, comprising at least one mould (1; 101; 201; 301; 401; 501) which includes a first mould part (2; 102; 202; 302; 402; 502) and a second mould part (3; 103; 203; 303; 403; 503) opposite to each other, a mould part selected from between the first mould part (2; 102; 202; 302; 402; 502) and the second mould part (3; 103; 203; 303; 403; 503) comprising a plurality of sectors (8; 108; 208; 308; 508) for at least partially forming a lateral surface of the object, the sectors (8; 108; 208; 308; 508) delimiting a variable-volume forming region (4) of the mould (1; 101; 201; 301; 401; 501), the apparatus further comprising a driving device for bringing the first mould part (2; 102; 202; 302; 402; 502) and the second mould part (3; 103; 203; 303; 403; 503) closer to each other along a moulding direction (D), so as to bring into mutual contact the first mould part (2; 102; 202; 302; 402; 502) and the second mould part (3; 103; 203; 303; 403; 503) along respective abutment surfaces (71, 72; 571, 572) arranged transversely to the moulding direction (D), defining a closed forming chamber (17) between the first mould part (2; 102; 202; 302; 402; 502) and the second mould part (3; 103; 203; 303; 403; 503), and wherein the apparatus further comprises pushing means for moving the sectors (8; 108; 208; 308; 508) transversely to the moulding direction (D) to reduce volume of the variable-volume forming region (4).

In a second version of the second aspect, an apparatus is provided according to the first version of the second aspect, wherein the sectors (8; 108; 208; 308; 508) are included in the first mould part (2; 102; 202; 302; 402; 502) and the second mould part (3; 103; 203; 303; 503) comprises an abutment element (16; 116; 216; 316; 516) adapted to contact the sectors (8; 108; 208; 308; 508) to define the closed forming chamber (17) and a forming component (15; 115; 215; 315; 515) at least partially surrounded by the abutment element (16; 116; 216; 316; 516), the forming component (15; 115; 215; 315; 515) and the abutment element (16; 116; 216; 316; 516) being distinct from each other and displaceable with respect to each other.

In a third version of the second aspect, an apparatus is provided according to the second version of the second aspect, wherein the second mould part comprises a blocking portion (280) adapted to be interposed between the sectors (8; 108; 208; 308; 508) for blocking an edge zone of the dosed amount (500) before starting to deform a central zone of the dosed amount (500).

In a fourth version of the second aspect, an apparatus is provided according to the third version of the second aspect, wherein the blocking portion (280) projects from the abutment element (16; 116; 216; 316; 516) to clamp the dosed amount (500) against a support surface (79; 579) of the first mould part (2; 102; 302: 402; 502), the sectors (8; 108; 208; 308; 508) of said plurality being slidable along the support surface (79; 579) to reduce the volume of the variable-volume forming region (4).

In a fifth version of the second aspect, an apparatus is provided according to one of the versions from the first to the fourth of the second aspect, wherein the sectors (8; 108; 208; 308; 508) are included in the first mould part (2; 102; 202; 302; 402; 502) and the first mould part (2; 102; 202; 302; 502) further comprises an end-forming element (14; 114; 214; 314; 514) delimiting the closed forming chamber (17) transversely to the moulding direction (D) on the opposite side with respect to the second mould part (3; 103; 203; 303; 503) and wherein a protruding core (73) projects from the end-forming element (14; 114; 214; 314; 514) towards the second mould part (3; 103; 203; 303; 503) to originate an object having a hole or a hollow starting from a dosed amount (100; 400; 500) positioned in the first mould part (2; 102; 202; 302; 502) in a non-centred position with respect to the sectors (8; 108; 208; 308; 508) of said plurality, at a side of the protruding core (73).

In a first version of a third aspect of the invention, a method is provided for forming an object, comprising the steps of:
providing a mould (501) comprising a first mould part (502) and a second mould part (503) opposite to each other;
positioning a dosed amount (500) of mouldable material between the first mould part (502) and the second mould part (503);
displacing the first mould part (502) and the second mould part (503) towards each other in a moulding direction (D), to form an object from the dosed amount (500) by means of compression moulding,
   wherein an edge zone of the dosed amount (500) is blocked between the first mould part (502) and the second mould part (503) before starting to deform a central zone of the dosed amount (500).

In a second version of the third aspect of the invention, a method is provided according to the first version of the third aspect of the invention, wherein the first mould part (502) comprises a forming cavity (24), the edge zone of the dosed amount (500) being blocked between the first mould part (502) and the second mould part (503) while the central zone of the dosed amount is spaced by a bottom of the forming cavity (24).

In a third version of the third aspect of the invention, a method is provided according to the first or second version of the third aspect of the invention, wherein the second mould part (503) comprises an abutment element (516) adapted to contact the first mould part (502) to define a closed forming chamber (17) between the first mould part (502) and the second mould part (503), the second mould part (503) further comprising a forming component (515) at least partially surrounded by the abutment element (516), the forming component (515) and the abutment element (516) being distinct from each other and displaceable with respect to each other, and wherein the dosed amount (500) is blocked between the first mould part (502) and the second mould part (503) by a blocking portion (280) projecting from the abutment element (516) and pushing the dosed amount (500) against the first mould part (502).

In a first version of a fourth aspect of the invention, an apparatus is provided for forming an object from a dosed amount (500) of mouldable material, comprising at least one mould which includes a first mould part (502) and a second mould part (503) opposite to each other, a driving device for displacing the first mould part (502) and the second mould part (503) towards each other in a moulding direction (D), so as to form an object from the dosed amount (500) by means of compression moulding, wherein a mould part selected from between the first mould part (502) and the second mould part (503) comprises a blocking portion (280), intended to engage with an edge zone of the dosed amount (500) to press the edge zone against the other mould part selected from between the second mould part (503) and the first mould part (502), so as to block the dosed amount (500) in contact with the other mould part while the dosed amount (500) is shaped. In a second version of the fourth aspect of the invention, an apparatus is provided according to the first version of the fourth aspect of the invention, wherein the blocking portion (280) is included in the second mould part (503) and the first mould part (502) is a female mould part.

In a third version of the fourth aspect of the invention, an apparatus is provided according to the second version of the fourth aspect of the invention, wherein the second mould part (503) comprises an abutment element (516) adapted to contact the first mould part (502) to define a closed forming chamber (17) between the first mould part (502) and the second mould part (503), the second mould part (503) further comprising a forming component (515) at least partially surrounded by the abutment element (516), the forming component (515) and the abutment element (516) being distinct from each other and displaceable with respect to each other, and in which the blocking portion (280) projects from the abutment element (516) towards the first mould part (502).

1. A method for forming an object, comprising the steps of:
providing a mould comprising a first mould part and a second mould part opposite to each other, a part selected from between the first mould part and the second mould part comprising a plurality of sectors for shaping at least a lateral portion of the object, the sectors delimiting a variable-volume forming region of the mould;
positioning a dosed amount of mouldable material between the first mould part and the second mould part while the mould is in an open position;
displacing the first mould part and the second mould part towards each other in a moulding direction, to define between the first mould part and the second mould part a closed forming chamber by bringing into contact respective abutment surfaces of the first mould part and of the second mould part, the abutment surfaces extending transversely to the moulding direction,
the method further comprising the step of moving the sectors transversely to the moulding direction in order to reduce volume of the variable-volume forming region, and wherein the mould comprises a forming component which penetrates into the variable-volume forming region, thereby compressing the mouldable material in the moulding direction.

2. The method according to claim 1, wherein the sectors of said plurality delimit a lateral surface of the variable-volume forming region, the sectors of said plurality being movable between a first position in which the volume of the variable-volume forming region is maximum, and a second position, in which the volume of the variable-volume forming region is minimum, and wherein the dosed amount is positioned between the first mould part and the second mould part while the sectors of said plurality are in the first position.

3. The method according to claim 1, wherein the closed forming chamber is defined by bringing into mutual contact the sectors of said plurality and an abutment element of a mould part selected from between the second mould part and the first mould part and facing the sectors, said forming component being included in the mould part facing the sectors and arranged inside the abutment element.

4. The method according to claim 3, wherein after the sectors of said plurality and the abutment element have been brought into mutual contact, one mould part selected from between the first mould part and the second mould part is displaced further in the moulding direction, so that the forming component penetrates between the sectors of said plurality to form the object.

5. The method according to any preceding claim 1, wherein the forming component is a male forming component, the mouldable material flowing between the sectors of said plurality and the male forming component to originate a lateral wall of the object.

6. The method according to claim 5, wherein the male forming component is located below the first mould part and the dosed amount is positioned on a support surface delimiting an upper end of the male forming component.

7. (canceled)

8. The method according to claim 1, wherein the first mould part further comprises an end-forming element delimiting the closed forming chamber transversely to the moulding direction at the opposite side with respect to the second mould part.

9. The method according to claim 8, wherein the sectors of said plurality are slidable transversely to the moulding direction in contact with the end-forming element to decrease volume of the closed forming chamber.

10. (canceled)

11. The method according to claim 8, wherein the first mould part comprises a protruding core protruding from the end-forming element towards the second mould part, and wherein the dosed amount is positioned in the first mould part in a non-centred position with respect to the sectors of said plurality, at a side of the protruding core, so that the mouldable material flows between the sectors of said plurality and the protruding core to create an object having a hole or a hollow.

12. The method according to claim 11, wherein the protruding core protrudes from the sectors of said plurality towards the second mould part to engage in a guide hole made in the forming component.

13. (canceled)

14. The method according to claim 1, and further comprising extruding the mouldable material, thereby generating a continuous extrudate of mouldable material, separating a dosed amount from the continuous extrudate, transporting the dosed amount into the mould.

15. The method according to claim 1, wherein the sectors are movable transversely to the moulding direction between an enlarged configuration and a final configuration of the variable-volume forming region, the dosed amount being released between the first mould part and the second mould part while the sectors are in the enlarged configuration, the dosed amount having smaller transverse dimensions than the transverse dimensions of the variable-volume forming region in the enlarged configuration, the transverse dimensions of the dosed amount and of the variable-volume forming region in the enlarged configuration being measured perpendicular to the moulding direction.

16. The method according to claim 1, wherein the step of positioning a dosed amount of mouldable material between the first mould part and the second mould part comprises resting the dosed amount on a mould part selected from between the first mould part and the second mould part in a position where the dosed amount is at least partially surrounded by the sectors and spaced from the sectors, the sectors being subsequently moved transversely to the moulding direction to come into contact with the dosed amount.

17. The method according to claim 1, wherein the step of moving the sectors transversely to the moulding direction starts before the closed forming chamber has been defined.

18. The method according to claim 1, wherein the step of moving the sectors transversely to the moulding direction starts after the closed forming chamber has been defined.

19. (canceled)

20. The method according to claim 1, and further comprising the step of blocking an edge zone of the dosed amount between the first mould part and the second mould part before starting to deform a central zone of the dosed amount.

21. The method according to claim 20, wherein the first mould part has a forming cavity, and wherein the edge zone of the dosed amount is blocked between the first mould part and the second mould part when the central zone of the dosed amount is spaced from a bottom of the forming cavity.

22. The method according to claim 20, wherein the sectors are included in the first mould part, and wherein the edge zone of the dosed amount is rested on the first mould part and blocked between the first mould part and the second mould part before the forming component starts to interact with the central zone of the dosed amount.

23-24. (canceled)

25. An apparatus for forming an object, comprising at least one mould which includes a first mould part and a second mould part opposite to each other, a mould part selected from between the first mould part and the second mould part comprising a plurality of sectors for at least partially forming a lateral surface of the object, the sectors delimiting a variable-volume forming region of the mould, the apparatus further comprising a driving device for displacing the first mould part and the second mould part with respect to each other along a moulding direction between an open position, in which a dosed amount of mouldable material is positioned between the first mould part and the second mould part, and a mutual contact position in which the first mould part and the second mould part are in contact along respective abutment surfaces arranged transversely to the moulding direction and a closed forming chamber is defined between the first mould part and the second mould part, and wherein the sectors are movable transversely to the moulding direction to reduce volume of the variable-volume forming region.

26. The apparatus according to claim 25, wherein the first mould part further comprises an end-forming element which delimits the closed forming chamber transversely to the moulding direction at the opposite side with respect to the second mould part and wherein a protruding core projects from the end-forming element towards the second mould part for creating an object having a hole or a hollow starting from a dosed amount positioned in the first mould part in a non-centred position with respect to the sectors of said plurality, at a side of the protruding core.
